(19) United States
(12) Patent Application Publication
(10) Pub. No.: US 2026/0057545 A1
(43) Pub. Date: Feb. 26, 2026

(54) METHOD AND APPARATUS FOR DETERMINING THREE-DIMENSIONAL INFORMATION, DEVICE, STORAGE MEDIUM, AND PROGRAM PRODUCT

(71) Applicant: Tencent Technology (Shenzhen) Company Limited, Shenzhen (CN)

(72) Inventors: Jiawen ZHENG, Shenzhen (CN); Yundong ZHANG, Shenzhen (CN); Bishan WANG, Shenzhen (CN); Hong SHANG, Shenzhen (CN); Zhongqian SUN, Shenzhen (CN)

(21) Appl. No.: 19/374,368

(22) Filed: Oct. 30, 2025

Related U.S. Application Data
(63) Continuation of application No. PCT/CN2024/116589, filed on Sep. 3, 2024.

(30) Foreign Application Priority Data
Oct. 24, 2023 (CN) 202311378630.8

(51) Int. Cl. G06T 7/73; G06T 7/10; G06T 7/80

(52) U.S. Cl. CPC G06T 7/73; G06T 7/10; G06T 7/80; G06T 2207/10012; G06T 2207/20132

(57) ABSTRACT

A method for determining three-dimensional information of an object is performed by a computer device. The method includes: obtaining an image of an outer surface of a photographed object, the outer surface of the photographed object having n protruding stereoscopic units, and n being a positive integer; processing the image, to obtain frame information of at least one stereoscopic unit, the frame information including a first surface and a second surface of the stereoscopic unit in the image, the first surface being parallel to the second surface; and determining three-dimensional information of the stereoscopic unit based on the frame information of the stereoscopic unit, the three-dimensional information representing a position of the stereoscopic unit in the image and a protrusion degree of the stereoscopic unit in a direction perpendicular to the outer surface. This method helps reduce difficulty in obtaining three-dimensional information of a stereoscopic unit.

### CROSS-REFERENCE TO RELATED APPLICATIONS

This application is a continuation application of PCT Patent Application No. PCT/CN2024/116589, entitled “METHOD AND APPARATUS FOR DETERMINING THREE-DIMENSIONAL INFORMATION, DEVICE, STORAGE MEDIUM, AND PROGRAM PRODUCT” filed on Sep. 3, 2024, which claims priority to Chinese Patent Application No. 2023113786308, entitled “METHOD AND APPARATUS FOR DETERMINING THREE-DIMENSIONAL INFORMATION, DEVICE, AND STORAGE MEDIUM” filed with the China National Intellectual Property Administration on Oct. 24, 2023, all of which are incorporated by reference in their entirety.

### FIELD OF THE TECHNOLOGY

This application relates to the field of image processing technologies, and in particular, to determining of three-dimensional information.

### BACKGROUND OF THE DISCLOSURE

A stereoscopic unit is detected and identified in an image, to obtain information related to a position and a size of the stereoscopic unit. This facilitates reconstruction of the stereoscopic unit.

In a related technology, three-dimensional information of the stereoscopic unit in the image is determined by using a deep learning model and based on the image and a camera intrinsic parameter for photographing the image. Because different cameras have independent camera intrinsic parameters, this method can be performed only when the camera intrinsic parameter corresponding to the image is obtained. The method for determining three-dimensional information has a low adaptability to a scenario, and the method for determining three-dimensional information further needs to be improved.

### SUMMARY

This application provides a method and an apparatus for determining three-dimensional information, a device, a storage medium, and a program product, to identify a stereoscopic unit in an image without obtaining other external reference information (such as a camera intrinsic parameter). The technical solutions are as follows.

According to an aspect of embodiments of this application, a method for determining three-dimensional information is performed by a computer device, the method including:
obtaining an image of an outer surface of a photographed object, the outer surface of the photographed object having n protruding stereoscopic units, and n being a positive integer;
processing the image, to obtain frame information of at least one stereoscopic unit, the frame information including a first surface and a second surface of the stereoscopic unit in the image, the first surface being parallel to the second surface; and
determining three-dimensional information of the stereoscopic unit based on the frame information of the stereoscopic unit, the three-dimensional information representing a position of the stereoscopic unit in the image and a protrusion degree of the stereoscopic unit in a direction perpendicular to the outer surface.

According to an aspect of embodiments of this application, a computer device is provided, the computer device including a processor and a memory, the memory having a computer program stored therein, and the computer program, when being loaded and executed by the processor, causing the computer device to implement the method for determining three-dimensional information as described above.

According to an aspect of embodiments of this application, a non-transitory computer-readable storage medium is provided, the storage medium having a computer program stored therein, and the computer program, when being loaded and executed by a processor of a computer device, causing the computer device to implement the method for determining three-dimensional information as described above.

The technical solutions provided in embodiments of this application achieve at least the following beneficial effects.

In the method provided in this application, to determine the three-dimensional information of the stereoscopic unit, only the image obtained by photographing the photographed object needs to be used, and the image is processed, to obtain the frame information configured for positioning the position of the stereoscopic unit in the image. Subsequently, based on an imaging rule of a plurality of stereoscopic units on the outer surface of the photographed object, the three-dimensional information of the stereoscopic unit may be obtained by using only the frame information of the stereoscopic unit. Compared with a related technology in which external reference information such as a camera intrinsic parameter needs to be used to determine depth information of the stereoscopic unit, in this method, when the three-dimensional information of the stereoscopic unit is determined, other external reference information (such as the camera intrinsic parameter) does not need to be obtained. An amount of reference information that needs to be used to determine the three-dimensional information of the stereoscopic unit is reduced, and the three-dimensional information of the stereoscopic unit is determined based only on the image. This method helps improve an adaptability of the method for determining three-dimensional information to different scenarios, and helps reduce difficulty in obtaining the three-dimensional information of the stereoscopic unit.

### BRIEF DESCRIPTION OF THE DRAWINGS

FIG. 1 is a schematic diagram of an implementation environment of a solution according to an exemplary embodiment of this application.

FIG. 2 is a schematic diagram of a vanishing point of an image during perspective projection.

FIG. 3 is a schematic diagram of perspective distortion occurring in a process of perspective imaging.

FIG. 4 is a schematic diagram of identifying a stereoscopic unit from an image based on image segmentation in a related technology.

FIG. 5 is a schematic diagram of an inventive idea of a method for determining three-dimensional information according to an embodiment of this application.

FIG. 6 is a schematic diagram of a principle of determining three-dimensional information according to an exemplary embodiment of this application.

FIG. 7 is a flowchart of a method for determining three-dimensional information according to an exemplary embodiment of this application.

FIG. 8 is a schematic diagram of a surface of a stereoscopic unit according to an exemplary embodiment of this application.

FIG. 9 is a schematic diagram of a process of determining a second surface position according to an exemplary embodiment of this application.

FIG. 10 is a schematic diagram of a process of determining a vanishing point according to an exemplary embodiment of this application.

FIG. 11 is a schematic diagram of comparison between frame information and position information according to an exemplary embodiment of this application.

FIG. 12 is a schematic diagram of a corrected stereoscopic unit according to an exemplary embodiment of this application.

FIG. 13 is a schematic diagram of image cropping and correction according to an exemplary embodiment of this application.

FIG. 14 is a schematic diagram of a process of determining frame information according to an exemplary embodiment of this application.

FIG. 15 is a schematic diagram of a method for determining three-dimensional information according to an exemplary embodiment of this application.

FIG. 16 is a block diagram of an apparatus for determining three-dimensional information according to an exemplary embodiment of this application.

FIG. 17 is a structural block diagram of a computer device according to an exemplary embodiment of this application.

### DESCRIPTION OF EMBODIMENTS

To make the objectives, technical solutions, and advantages of this application clearer, the following further describes implementations of this application in detail with reference to the accompanying drawings.

A street-scape image is a panorama image of an area such as a street, a city, or a countryside that is obtained by using a device such as an in-vehicle camera or a handheld camera. The image in the claims may be a street-scape image. The street-scape image is configured for displaying content such as a corresponding street, a building, a traffic sign, and a pedestrian. The street-scape image is widely applied to fields such as electronic map manufacturing, city planning, travel navigation, and education research.

A building unit is design and decoration on an external wall or a facade of a building, and is an important constituent part of appearance of the building. The stereoscopic unit mentioned in the claims of this application may be a building unit. Types of the foregoing building unit may include, but are not limited to, at least one of the following: a window, a balcony, and a door.

A stereoscopic bounding box is configured for representing an edge box of a stereoscopic unit in an image. The stereoscopic bounding box may be referred to as a three-dimensional (3D) box. The stereoscopic bounding box includes an inner surface of the stereoscopic unit and an outer surface of the stereoscopic unit. In an application scenario of this application, the inner surface of the stereoscopic unit is a surface that is in contact with a photographed object and that is in the stereoscopic unit, and the outer surface of the stereoscopic unit is parallel to the inner surface of the stereoscopic unit, that is, there may be a distance between the outer surface of the stereoscopic unit and an outer surface of the photographed object. Due to perspective imaging of the camera, imaging of the outer surface of the stereoscopic unit in the image is usually larger than imaging of the inner surface of the stereoscopic unit in the image.

A vanishing point is an imaging convergence point in an image of a beam of parallel lines not parallel to a projection surface in three-dimensional space during perspective projection. The vanishing point is also referred to as a disappearing point.

A camera intrinsic parameter is an intrinsic parameter of a camera. The camera intrinsic parameter includes at least one of the following: a camera focal length, a pixel size, a principal point position, and the like.

Perspective distortion refers to a rule that, in an image obtained by photographing a photographed object, an imaging size of the photographed object in the image is related to a distance between the photographed object and a camera. Because construction of the camera is to imitate a function of a visual perspective capability of human eyes, imaging of the camera also conforms to a near-large and far-small principle. A photographed object that is close to the camera has a large imaging size in the image, and a photographed object that is far away from the camera has a small imaging size in the image.

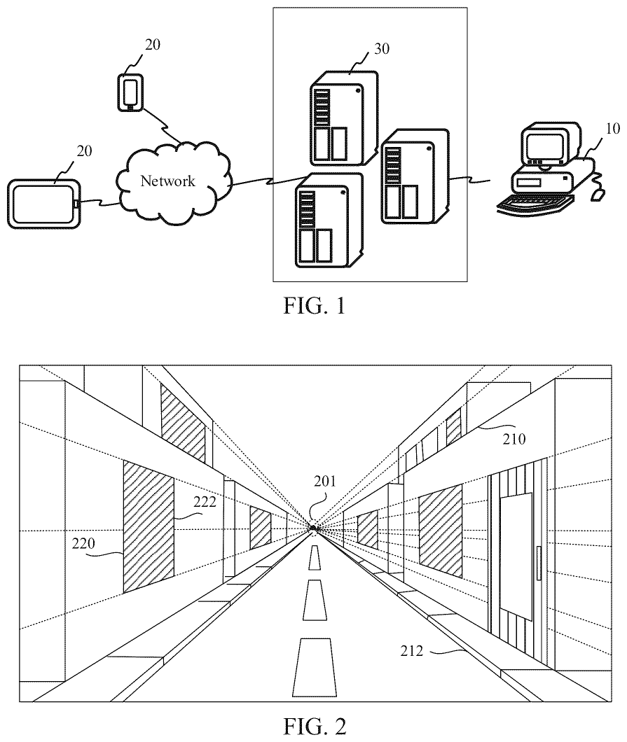

FIG. 1 is a schematic diagram of an implementation environment of a solution according to an exemplary embodiment of this application. The implementation environment of the solution includes a computer device 10, a terminal device 20 and a server 30.

The computer device 10 may include, but is not limited to, an electronic device with computing and storage capabilities such as a personal computer (PC), a tablet computer, a mobile phone, a wearable device, a smart home appliance, or an in-vehicle terminal. In some embodiments, the computer device is configured to obtain an image and predict three-dimensional information of a stereoscopic unit included in the image.

The terminal device 20 may be an electronic device such as a personal computer, a tablet computer, a mobile phone, a wearable device, a smart home appliance, an in-vehicle terminal, or an aircraft. A camera is disposed on the terminal device 20, or image transmission exists between the terminal device 20 and the camera. The terminal device 20 obtains, by using the camera, an image obtained by photographing a photographed object. A photographed plane of the photographed object includes a plurality of stereoscopic units, and the image includes imaging of the stereoscopic units.

There is a client running a target application program in the terminal device 20. The target application program is configured to provide an obtaining function of three-dimensional information of the stereoscopic unit. For example, the terminal device 20 obtains, by using the target application program, the three-dimensional information of the stereoscopic unit included in the image, to execute tasks such as city recovery, street-scape reconstruction, autonomous driving, and vehicle navigation based on the three-dimensional information of the stereoscopic unit.

The server 30 is configured to provide a backend service for the client of the target application program in the terminal device 20. For example, the server 30 may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligent platform, but is not limited thereto. The server 30 has at least a data receiving function.

In one embodiment, a function of determining three-dimensional information of the computer device 10 may be implemented by using the server 30 (where the computer device 10 and the server 30 are the same device), or the computer device 10 and the server 30 are two devices independent of each other.

In an example, after receiving an image that is uploaded by the terminal device 20 by using the target application program, the server 30 transmits the image to the computer device 10. The computer device 10 receives the image transmitted by the server 30 and processes the image, to determine the three-dimensional information of the stereoscopic unit. The computer device 10 transmits the three-dimensional information of the stereoscopic unit to the server 30, and the server 30 forwards the three-dimensional information of the stereoscopic unit to the terminal device 20.

In another example, the computer device 10 obtains an image through a network and determines the three-dimensional information of the stereoscopic unit from the image. Subsequently, the computer device 10 may perform three-dimensional reconstruction on the photographed object by using the three-dimensional information of the stereoscopic unit.

FIG. 2 is a schematic diagram of a vanishing point of an image during perspective projection. As shown in FIG. 2, affected by perspective imaging, imaging (including a straight line 210 and a straight line 212) of a beam of parallel lines not parallel to a projection surface in an image intersects with a vanishing point 201. Imaging (including a straight line 220 and a straight line 222) of a beam of parallel lines parallel to the projection surface in the image remains parallel.

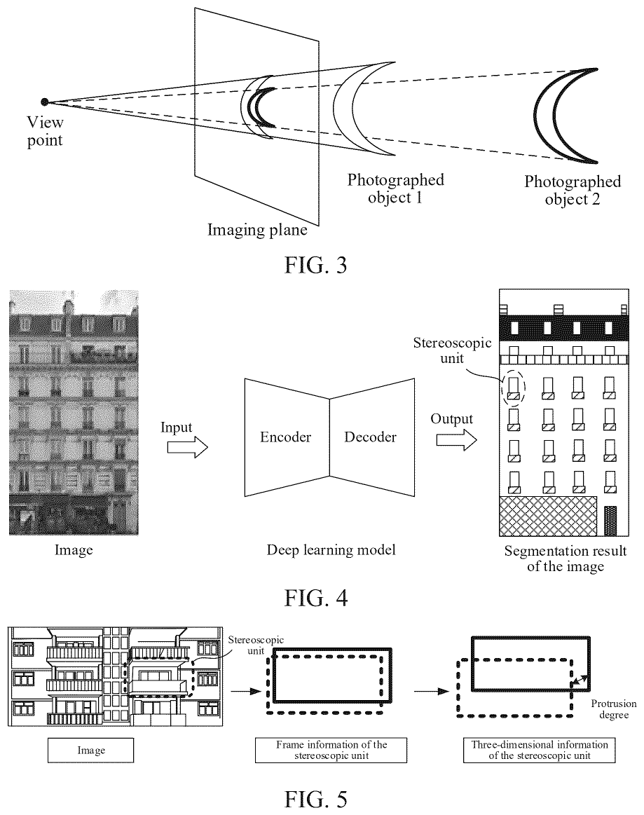

FIG. 3 is a schematic diagram of perspective distortion occurring in a process of perspective imaging. As shown in FIG. 3, a photographed object 1 and a photographed object 2 are of the same size. A distance between the photographed object 1 and a viewpoint is greater than a distance between the photographed object 2 and the viewpoint. A size of the photographed object 1 in an imaging plane (where the imaging plane is the same as content in a photographed image, the image is on a left side of a camera in the figure, the imaging plane is on a right side of the camera, and a distance between the image and the viewpoint is equal to a distance between the imaging plane and the viewpoint) is greater than a size of the photographed object 2 in the imaging plane. In other words, perspective distortion makes the photographed object conform to a near-large and far-small rule in the image.

In a related technology, detection of a shape of a stereoscopic unit based on an image includes the following several methods. One method is to establish a shape syntax rule based on an arrangement rule of stereoscopic units on an outer surface of a photographed object. The image is processed based on the shape syntax rule, to predict a geometrical shape (for example, a shape of the outer surface) of the stereoscopic unit.

Another method is to segment the image by using a deep learning model, to determine a position of the stereoscopic unit in the image, and determine a geometrical shape of the stereoscopic unit. FIG. 4 is a schematic diagram of identifying a stereoscopic unit based on image segmentation in a related technology. As shown in FIG. 4, in the related technology, an image is input into a deep learning model, an encoder in the deep learning model encodes the image to obtain encoded information, and a decoder in the deep learning model decodes the encoded information to obtain a segmentation result of the image. Each fill pattern in the segmentation result corresponds to one stereoscopic unit.

Because an image obtained by photographing the photographed object is a two-dimensional image, the image cannot completely represent each surface of the stereoscopic unit. In other words, at least one surface (at least one surface parallel to a normal line of an outer surface of the photographed object) of the stereoscopic unit cannot completely appear in the image. In this way, in both the methods provided in the related technology, depth information of the stereoscopic unit cannot be obtained based only on the image. In other words, a protrusion degree of the stereoscopic unit in a direction perpendicular to the outer surface of the photographed object cannot be determined based only on the image.

To determine three-dimensional information of the stereoscopic unit, a camera intrinsic parameter needs to be obtained in the related technology, and the three-dimensional information of the stereoscopic unit is predicted by using the camera intrinsic parameter and the image. Because the camera intrinsic parameter is an intrinsic parameter of a camera, and is affected by factors such as a photographing element and an assembly error in the camera, there is an individual difference between camera intrinsic parameters. It is difficult to unify camera intrinsic parameters of cameras. Therefore, in a method for determining three-dimensional information of a stereoscopic unit by using a camera intrinsic parameter and an image, a camera intrinsic parameter corresponding to a camera used for photographing an image needs to be obtained. In some scenarios, it is difficult to obtain a camera intrinsic parameter corresponding to an image or the parameter cannot be obtained (for example, it is difficult to determine a camera intrinsic parameter corresponding to an image downloaded from a network), resulting in a poor adaptability, to different scenarios, of the method for determining three-dimensional information of a stereoscopic unit in the related technology.

FIG. 5 is a schematic diagram of an inventive idea of a method for determining three-dimensional information according to an embodiment of this application.

The method provided in this application is configured for determining, based on an image, three-dimensional information of a stereoscopic unit protruding on an outer surface of a photographed object. An inner surface of the stereoscopic unit is in contact with the outer surface of the photographed object, in other words, the inner surface of the stereoscopic unit is in the outer surface of the photographed object. In the method provided in this application, only an image obtained by photographing the photographed object is obtained, and the three-dimensional information of the stereoscopic unit can be determined without using other external information (such as a camera intrinsic parameter), to obtain a size and a position of the stereoscopic unit and a protrusion degree of the stereoscopic unit.

In the method for determining three-dimensional information provided in this application, frame information of at least one stereoscopic unit is determined from the image. Subsequently, the three-dimensional information of the stereoscopic unit is determined based on a rule of perspective projection of the stereoscopic unit on the outer surface of the photographed object and the frame information of the stereoscopic unit. According to this method, dependency on external reference information in a process of determining the three-dimensional information is reduced, to reduce difficulty in determining the three-dimensional information of the stereoscopic unit to collect reference information.

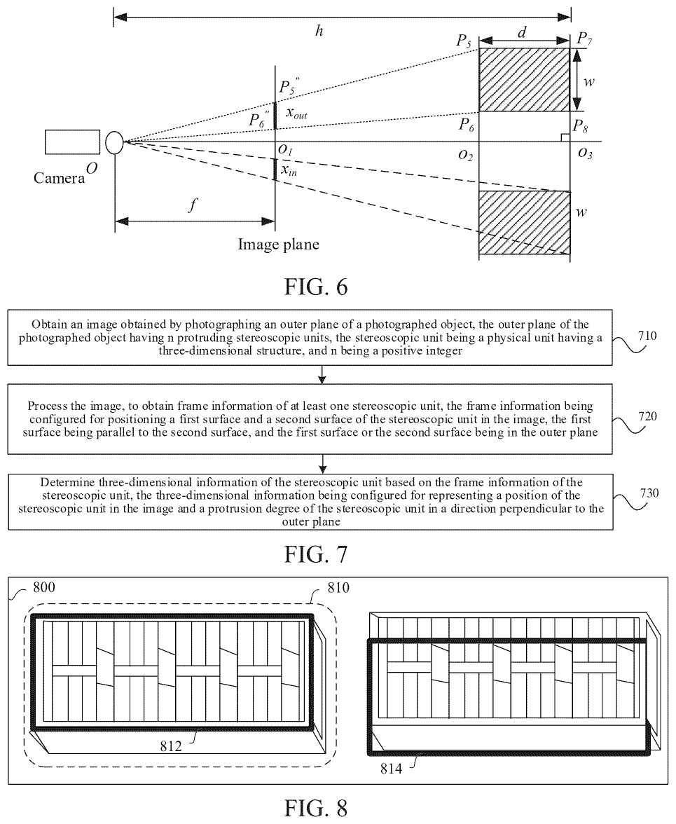

FIG. 6 is a schematic diagram of a principle of determining three-dimensional information according to an exemplary embodiment of this application.

As shown in FIG. 6, it is assumed that h represents a distance (that is, an object distance) between a stereoscopic unit and a camera; d represents a true thickness of the stereoscopic unit (a protrusion degree of the stereoscopic unit on an outer surface of a photographed object), and |P₅P₇|=d in FIG. 6. w is a real width of the object, and |P₇P₈|=w in FIG. 6. A projection of an outer surface of the stereoscopic unit in an imaging plane is represented as xₒᵤₜ, and

$$\vert {P}_{5}^{″} {P}_{6}^{″} \vert = {x}_{out} .$$

A projection of an inner surface of the stereoscopic unit in the imaging plane is xᵢₙ. P₅, P₆ represent vertexes on the outer surface of the stereoscopic unit,

$${P}_{5}^{″} , {P}_{6}^{″}$$

represent vertexes of the outer surface of the stereoscopic unit in the imaging plane, and O represents a lens center point of the camera.

Because light propagates along a straight line, when the camera photographs the stereoscopic unit,

$$Δ {OP}_{5}^{″} {P}_{6}^{″}$$

and ΔOP₅P₆ are similar triangles, and

$$Δ {OP}_{6}^{″} {O}_{1}$$

and ΔOP₆O₂ are also similar triangles, there is a ratio relationship (1) between

$${OP}_{6}^{″}$$

### and OP₆:

$$\frac{O {P}_{6}^{″}}{O {P}_{6}} = \frac{{x}_{o u t}}{w} = \frac{f}{h - d} \qquad ( 1 )$$

f represents a focal length of the camera. For other parameters, refer to the foregoing descriptions. Details are not described herein again.

For stereoscopic units in the same image, f and h are constants.

$${OP}_{6}^{″}$$

and OP₆ are in a positive correlation with the true thickness d of the stereoscopic unit. In other words, a larger true thickness d indicates a shorter distance between the outer surface of the stereoscopic unit and the camera, and larger imaging of the stereoscopic unit in the imaging plane. A smaller true thickness d indicates a longer distance between the outer surface of the stereoscopic unit and the camera, and smaller imaging of the stereoscopic unit in the imaging plane.

When the true thickness d of the stereoscopic unit=0, an inner surface overlaps with the outer surface of the stereoscopic unit. Based on the ratio relationship (1) between

$${OP}_{6}^{″}$$

and OP₆, a ratio relationship (2) of the inner surface in the imaging plane is obtained:

$$\frac{{x}_{i n}}{w} = \frac{f}{h} \qquad ( 2 )$$

For meanings of the parameters in the formula, refer to the foregoing descriptions. Details are not described herein again.

Based on (2)/(1), a relative protrusion degree

$$\frac{{x}_{in}}{{x}_{out}} = \frac{h - d}{h} = 1 - \frac{d}{h} = α$$

between the inner surface and the outer surface is obtained.

α represents a size ratio (corresponding to the surface ratio in the claims) between the inner surface and the outer surface of the stereoscopic unit in the imaging plane. In other words, the size ratio α between the inner surface and the outer surface in the imaging plane is related only to a true protrusion degree d of the object, and d∝(1−α). Relative protrusion between a stereoscopic unit 1 and a stereoscopic unit 2 on the outer surface of the photographed object is calculated by using the following formula:

$$\frac{{d}_{1}}{{d}_{2}} = \frac{( 1 - {α}_{1} )}{( 1 - {α}_{2} )} \qquad ( 3 )$$

It can be learned from the foregoing deduction that: 1. The protrusion degree of the stereoscopic unit can be obtained by calculating a ratio between the inner surface and the outer surface of the stereoscopic unit. 2. In the same depth plane (for example, the outer surface of the photographed object), relative sizes and positions of a plurality of stereoscopic units in an image are consistent with those of the plurality of stereoscopic units in three-dimensional space. 3. Stereoscopic units in different depth planes also satisfy a near-large and far-small rule for imaging.

The foregoing conclusion supports predicting sizes and positions of the inner surface and the outer surface of the stereoscopic unit based on frame information of the stereoscopic unit after the frame information of the stereoscopic unit is obtained. In addition, a relative protrusion degree between stereoscopic units in the same depth plane can be calculated without determining a camera intrinsic parameter. A method for determining three-dimensional information provided in this application is described below by using several embodiments.

FIG. 7 is a flowchart of a method for determining three-dimensional information according to an exemplary embodiment of this application. For example, an execution body of the method may be the computer device 10 in FIG. 1. The following describes the method for determining three-dimensional information by using the computer device as the execution body. As shown in FIG. 2, the method may include the following several operations (710 to 730).

Operation 710: Obtain an image obtained by photographing an outer surface of a photographed object, the outer surface of the photographed object having n protruding stereoscopic units, the stereoscopic unit being a physical unit having a three-dimensional structure, and n being a positive integer.

In some embodiments, the photographed object is an object whose outer surface has at least one protrusion unit. Types of the photographed object include, but are not limited to, at least one of the following: a building, a floor, a plate, and the like. In one embodiment, the outer surface of the photographed object is a surface of the photographed object on which the stereoscopic unit protrudes. For example, the photographed object is a building, and the outer surface of the photographed object is an outer facade of the building. For a building whose three-dimensional form is a cuboid, the outer facade of the building is a side surface that is perpendicular to the ground and that is in the building. For another example, if the photographed object is a site, the outer surface of the photographed object is the ground in the site. For example, the image includes a part of the outer surface of the photographed object, or the image includes a complete outer surface of the photographed object.

In some embodiments, the stereoscopic unit is a three-dimensional entity having a fixed relative position relationship with the photographed object. In one embodiment, the three-dimensional structure of the stereoscopic unit includes a first surface and a second surface that are parallel to each other. Types of the three-dimensional structure of the stereoscopic unit include, but are not limited to: a cuboid, a cylinder, and the like.

For example, the photographed object is a building, and the stereoscopic unit includes, but is not limited to, a window, a balcony, an archway, and a protruding ornament on an outer surface of the building. For example, the photographed object is the ground, and the stereoscopic unit includes, but is not limited to, a stereoscopic object (for example, a vehicle) and a building placed in a site. For example, the photographed object is a plate, and the stereoscopic unit includes, but is not limited to, an ornament or an adhesive that protrudes from an outer surface of the plate.

In one embodiment, the stereoscopic unit is fastened on the outer surface of the photographed object. For example, an inner surface of the stereoscopic unit is in the outer surface of the photographed object. In other words, the inner surface of the stereoscopic unit overlaps with the outer surface of the photographed object.

FIG. 8 is a schematic diagram of a surface of a stereoscopic unit according to an exemplary embodiment of this application.

A stereoscopic unit 810 protrudes from an outer surface 800 of a photographed object. An outer surface 812 of the stereoscopic unit 810 protrudes from the outer surface 800 of the photographed object and is parallel to the outer surface 800 of the photographed object. An outer surface 814 of the stereoscopic unit 810 is on the surface 800 of the photographed object.

In some embodiments, an image that is obtained by photographing the outer surface of the photographed object by a camera and that is obtained by a computer device includes at least one complete stereoscopic unit. Types of the camera include, but are not limited to, an in-vehicle camera, a camera, and the like. In one embodiment, the image includes imaging of a plurality of stereoscopic units, so that the image can provide more auxiliary information for a process of determining three-dimensional information of the stereoscopic unit, to help improve accuracy of a determined position and size of the stereoscopic unit.

In some embodiments, the n stereoscopic units include at least one type of stereoscopic units. Stereoscopic units of the same type have the same three-dimensional structure, and stereoscopic units of different types have different three-dimensional structures. In one embodiment, the image obtained by photographing the outer surface of the photographed object includes at least two different types of stereoscopic units. Protrusion degrees of different stereoscopic units in a direction perpendicular to the outer surface of the photographed object may be the same or may be different. In one embodiment, the image is an image photographed by a monocular camera. The method provided in this application has a low requirement on the camera, and an image photographed by a conventional camera may be used as the image used in the process of determining the three-dimensional information in this application. The image may alternatively be a point cloud image obtained through scanning, to carry more image information and improve accuracy of the determined three-dimensional information.

In some embodiments, a source of the image includes, but is not limited to, at least one of the following: photographing a photographed object by a camera, downloading the photographed object from the Internet, or uploading by a user.

For example, in a process of establishing a navigation map, buildings on both sides of a road are photographed by using an in-vehicle camera of an in-vehicle terminal, to obtain a street-scape image. The computer device receives the image transmitted by the in-vehicle terminal. For another example, the computer device obtains, by using an aerial photography device, a top-view image photographed for a road. For another example, in a process of manufacturing a virtual scenario such as a game, a virtual building needs to be disposed. The computer device obtains an image through the Internet and obtains, based on the image, three-dimensional information of a stereoscopic unit included in the image, to reconstruct the stereoscopic unit in the game scenario, to obtain the virtual building. In one embodiment, image attributes such as image resolution are set based on an actual requirement. This is not limited in this application herein.

Operation 720: Process the image, to obtain frame information of at least one stereoscopic unit, the frame information being configured for positioning the first surface and the second surface of the stereoscopic unit in the image, the first surface being parallel to the second surface, and the first surface or the second surface being in the outer surface.

In some embodiments, the frame information of the stereoscopic unit is configured for representing an imaging area of the stereoscopic unit in the image. In other words, the frame information of the stereoscopic unit indicates the imaging area of the stereoscopic unit in the image. It can be learned from the foregoing content that the stereoscopic unit has a three-dimensional structure. Therefore, the frame information of the stereoscopic unit can describe a stereoscopic frame of the stereoscopic unit in the image.

In some embodiments, sizes of the first surface and the second surface are the same, and a distance between the outer surface and the camera is greater than or equal to a distance between the inner surface and the camera. It can be learned from a perspective imaging principle described above that, affected by perspective distortion, shapes and sizes of the first surface and the second surface in the image are different.

In one embodiment, the frame information of the stereoscopic unit can represent positions and the sizes of the first surface of the stereoscopic unit and the second surface of the stereoscopic unit in the image. For example, the frame information of the stereoscopic unit includes coordinates of at least one positioning point of the first surface in the image, or coordinates of at least one positioning point of the second surface in the image. For another example, the frame information of the stereoscopic unit includes a parameter configured for calculating coordinates of at least one positioning point of the first surface in the image, or a parameter configured for calculating coordinates of at least one positioning point of the first surface in the image.

For example, the positioning point may be a vertex of the first surface or the second surface, or may be a center point of the first surface or the second surface. This is not limited in this application herein.

In one embodiment, one of the first surface and the second surface is the outer surface of the stereoscopic unit, and the other of the first surface and the second surface is the inner surface of the stereoscopic unit. For example, the first surface is the outer surface of the stereoscopic unit, and the second surface is the inner surface of the stereoscopic unit. For another example, the first surface is the inner surface of the stereoscopic unit, and the second surface is the outer surface of the stereoscopic unit.

In an example, the computer device obtains the frame information of the stereoscopic unit based on the image and by using an artificial intelligence model. For specific content of this part, refer to the following embodiments.

In one embodiment, in operation 720, the computer device determines the frame information corresponding to the at least one stereoscopic unit included in the image. For example, the computer device determines frame information of one stereoscopic unit in the image. For example, the computer device determines frame information of all the n stereoscopic units in the image. For another example, the computer device determines frame information of a plurality of stereoscopic units in the image, and positions of the plurality of stereoscopic units are adjacent in the image (the plurality of stereoscopic units may be all or a part of the n stereoscopic units). For example, because the at least one stereoscopic unit has different positions on the outer surface of the photographed object, the frame information of the at least one stereoscopic unit is different.

Operation 730: Determine three-dimensional information of the stereoscopic unit based on the frame information of the stereoscopic unit, the three-dimensional information being configured for representing a position of the stereoscopic unit in the image and a protrusion degree of the stereoscopic unit in a direction perpendicular to the outer surface.

In some embodiments, the three-dimensional information of the stereoscopic unit is configured for describing positions and forms of surfaces of the stereoscopic unit. In this operation, the computer device can determine the three-dimensional information of the stereoscopic unit by using only the frame information of the stereoscopic unit. This method helps reduce difficulty in calculating the three-dimensional information of the stereoscopic unit.

In one embodiment, the protrusion degree of the stereoscopic unit in the direction perpendicular to the outer surface is a direct protrusion degree of the stereoscopic unit relative to the outer surface in the direction perpendicular to the outer surface. In one embodiment, the protrusion degree of the stereoscopic unit in the direction perpendicular to the outer surface is a protrusion degree of a stereoscopic unit relative to another stereoscopic unit.

In one embodiment, the computer device may obtain, for any one of the at least one stereoscopic unit, the three-dimensional information of the stereoscopic unit based on the frame information of the stereoscopic unit. In one embodiment, the computer device jointly determines, for any one of the at least one stereoscopic unit, three-dimensional information of the stereoscopic unit based on the frame information of the at least one stereoscopic unit. For a specific process of determining the three-dimensional information, refer to the following embodiments.

In conclusion, in the method provided in this application, to determine the three-dimensional information of the stereoscopic unit, only the image obtained by photographing the photographed object needs to be used, and the image is processed, to obtain the frame information configured for positioning the position of the stereoscopic unit in the image. Subsequently, based on an imaging rule of the plurality of stereoscopic units on the outer surface of the photographed object, the three-dimensional information of the stereoscopic unit may be obtained by using only the frame information of the stereoscopic unit.

Compared with a related technology in which external reference information such as a camera intrinsic parameter needs to be used to determine depth information of the stereoscopic unit, in this method, when the three-dimensional information of the stereoscopic unit is determined, other external reference information (such as the camera intrinsic parameter) does not need to be obtained. An amount of reference information that needs to be used to determine the three-dimensional information of the stereoscopic unit is reduced, and the three-dimensional information of the stereoscopic unit is determined based only on the image. This method helps improve an adaptability of the method for determining three-dimensional information to different scenarios, and helps reduce difficulty in obtaining the three-dimensional information of the stereoscopic unit.

The method for determining three-dimensional information of a stereoscopic unit is described below by using several embodiments.

In some embodiments, the frame information includes a surface ratio, and the surface ratio is configured for representing a size ratio between the first surface and the second surface in the image.

In some embodiments, the surface ratio is configured for representing a ratio between a projection of the first surface in the image and a projection of the second surface in the image. In one embodiment, when the first surface and the second surface are both rectangles, the surface ratio can represent a length ratio between any side of the first surface and a corresponding side of the second surface. It can be learned from the foregoing deduction process that, two surfaces whose depths are different from an imaging plane (that is, the image mentioned in the specification) conform to the perspective imaging principle. In other words, length ratios between sides of the first surface and corresponding sides of the second surface are the same, and are all surface ratios.

For example, the computer device obtains the surface ratio from the frame information based on a surface ratio identifier. The surface ratio identifier is configured for representing a storage position of the surface ratio in the frame information.

In operation 730, the determining three-dimensional information of the stereoscopic unit based on the frame information of the stereoscopic unit may include the following several sub-operations (not shown in the accompanying drawings of the specification).

Sub-operation 732: The computer device determines position information of the stereoscopic unit based on the surface ratio of the stereoscopic unit, the position information being configured for representing the position of the stereoscopic unit in the image.

In one embodiment, the position information of the stereoscopic unit includes at least one of the following: a position of the first surface of the stereoscopic unit in the image and a position of the second surface of the stereoscopic unit in the image.

It can be learned from the foregoing content that the frame information of the stereoscopic unit is configured for positioning the stereoscopic unit in the image. For example, the frame information is configured for positioning the first surface of the stereoscopic unit and the second surface of the stereoscopic unit in the image. Affected by a photographing environment, definition of the first surface of the stereoscopic unit in the image may be different from definition of the second surface of the stereoscopic unit in the image. For example, when photographing is performed outdoors in a good lighting condition, imaging of the outer surface of the stereoscopic unit in the image is clearer than imaging of the inner surface of the stereoscopic unit in the image. For another example, when photographing is performed outdoors in a good lighting condition, and there is an auxiliary light source inside the photographed object, light on a side of the inner surface of the stereoscopic unit is stronger than light on a side of the outer surface of the stereoscopic unit.

This makes it difficult for the computer device to accurately position both the first surface of the stereoscopic unit and the second surface of the stereoscopic unit in the image based on the frame information of the stereoscopic unit determined based on the image. In other words, accuracy of positioning the first surface of the stereoscopic unit in the image based on the frame information is inconsistent with accuracy of positioning the second surface of the stereoscopic unit in the image based on the frame information.

In some embodiments, sub-operation 732 is configured for correcting the frame information of the stereoscopic unit based on the surface ratio, to obtain the position information. Compared with the frame information, the position information can be configured for more accurately positioning the position of the stereoscopic unit in the image.

In one embodiment, the computer device determines a second surface position based on the surface ratio and a first surface position in the frame information. The first surface position is configured for positioning a target surface in the image. The target surface is a surface on which accuracy of positioning based on the frame information is higher in the first surface and the second surface of the stereoscopic unit. The computer device obtains the position information of the stereoscopic unit based on the first surface position and the second surface position.

For example, the target surface is preset. For example, a surface representing the outer surface of the stereoscopic unit is determined as the target surface from the first surface and the second surface of the stereoscopic unit.

For specific content for determining the position information in this operation, refer to the following descriptions.

Sub-operation 734: The computer device determines protrusion information of the stereoscopic unit based on the surface ratio of the stereoscopic unit, the protrusion information being configured for representing the protrusion degree of the stereoscopic unit in the direction perpendicular to the outer surface.

The protrusion information may be configured for representing depth information of the stereoscopic unit in the image. In other words, the protrusion information is configured for representing the protrusion degree of the outer surface of the stereoscopic unit relative to the outer surface. In one embodiment, the protrusion degree represented by the protrusion information may be a relative protrusion degree, or may be an absolute protrusion degree. The relative protrusion degree is configured for representing the protrusion degree of the stereoscopic unit on the outer surface, and the absolute protrusion degree is configured for representing a distance between the outer surface of the stereoscopic unit and the outer surface, that is, a thickness of the stereoscopic unit in an outer plane. The absolute protrusion degree may be represented by using absolute protrusion. For a calculation method of the absolute protrusion, refer to the following embodiment.

In one embodiment, a surface ratio of a stereoscopic unit is in a negative correlation with a protrusion degree of the stereoscopic unit in the direction perpendicular to the outer surface. A larger surface ratio of a stereoscopic unit indicates a smaller protrusion degree of the stereoscopic unit in the direction perpendicular to the outer surface. A smaller surface ratio of a stereoscopic unit indicates a larger protrusion degree of the stereoscopic unit in the direction perpendicular to the outer surface.

Sub-operation 736: The computer device obtains the three-dimensional information of the stereoscopic unit based on the position information of the stereoscopic unit and the protrusion information of the stereoscopic unit.

In one embodiment, that the computer device obtains the three-dimensional information of the stereoscopic unit based on the position information of the stereoscopic unit and the protrusion information of the stereoscopic unit includes: The computer device combines the position information of the stereoscopic unit with the protrusion information of the stereoscopic unit, to obtain the three-dimensional information of the stereoscopic unit. For example, the three-dimensional information of the stereoscopic unit includes the position information of the stereoscopic unit and the protrusion information of the stereoscopic unit.

According to the foregoing method, the protrusion information of the stereoscopic unit can be calculated by using the surface ratio. In other words, all information that needs to be used in a process of determining the protrusion information can be obtained from the image, so that dependency on the external reference information (for example, the camera intrinsic parameter) in the process of determining the three-dimensional information of the stereoscopic unit is reduced, and a condition for determining the three-dimensional information of the stereoscopic unit is simplified.

The method for determining protrusion information is described below by using several embodiments.

In some embodiments, the image includes a plurality of stereoscopic units. In sub-operation 734, that the computer device determines protrusion information of the stereoscopic unit based on the surface ratio of the stereoscopic unit may include the following several operations (not shown in the accompanying drawings of the specification).

Sub-operation 734-a: The computer device determines, for a first stereoscopic unit in the plurality of stereoscopic units included in the image, relative protrusion of the first stereoscopic unit based on a surface ratio of the first stereoscopic unit and a surface ratio of a second stereoscopic unit. Protrusion degree of the second stereoscopic unit in the direction perpendicular to the outer surface is a known reference value, and the relative protrusion of the first stereoscopic unit is configured for representing a protrusion degree of the first stereoscopic unit relative to the second stereoscopic unit in the direction perpendicular to the outer surface.

In some embodiments, the first stereoscopic unit is a stereoscopic unit having frame information in the plurality of stereoscopic units. It can be learned from the foregoing content that the n stereoscopic units protrude from the outer surface of the photographed object, the image obtained by photographing the outer surface of the photographed object may include m stereoscopic units (corresponding to the plurality of stereoscopic units mentioned in sub-operation 734-a), and m is a positive integer less than or equal to n. The computer device may calculate frame information of k stereoscopic units in the m stereoscopic units in operation 720, where k is a positive integer less than or equal to m. In other words, the first stereoscopic unit may be any one of the k stereoscopic units.

To reduce a calculation amount of a process in which the computer device determines the three-dimensional information of the stereoscopic unit, and reduce time consumption of determining the three-dimensional information, the computer device selects the k stereoscopic units from the m stereoscopic units included in the image, and calculates three-dimensional information of each of the at least one stereoscopic unit, that is, k is usually less than m. For a method for selecting at least one stereoscopic unit from the image and determining frame information of the at least one stereoscopic unit, refer to the following embodiments.

For example, the computer device uses each of the plurality of stereoscopic units as the first stereoscopic unit, and performs sub-operation 734.

In some embodiments, the second stereoscopic unit is a reference stereoscopic unit that is in the plurality of stereoscopic units and that is configured to calculate the relative protrusion degree. In other words, the protrusion degree of the second stereoscopic unit in the direction perpendicular to the outer surface is the known reference value, and the known reference value may be preset. For example, staff set the known benchmark value according to experience.

In one embodiment, the second stereoscopic unit may be any one of the n stereoscopic units, and the image includes imaging of the second stereoscopic unit. For example, in operation 720, the computer device determines frame information of at least two stereoscopic units, where the at least two stereoscopic units include the second stereoscopic unit.

For example, the computer device obtains the surface ratio of the first stereoscopic unit from the frame information of the first stereoscopic unit, obtains the surface ratio of the second stereoscopic unit from the frame information of the second body unit, and determines the relative protrusion of the first stereoscopic unit based on the surface ratio of the first stereoscopic unit and the surface ratio of the second stereoscopic unit.

In some embodiments, the relative protrusion of the first stereoscopic unit is the protrusion degree of the first stereoscopic unit relative to the second stereoscopic unit in the direction perpendicular to the outer surface. When an inner surface of the first stereoscopic unit and an inner surface of the second stereoscopic unit are both in contact with the outer surface, the relative protrusion of the first stereoscopic unit is a ratio between a true thickness of the first stereoscopic unit and a true thickness of the second stereoscopic unit. It can be learned from the foregoing deduction of FIG. 6 that the relative protrusion of the first stereoscopic unit is related to the surface ratio of the first stereoscopic unit and the surface ratio of the second stereoscopic unit.

In some embodiments, the relative protrusion of the first stereoscopic unit is in a negative correlation with the surface ratio of the first stereoscopic unit. The relative protrusion of the first stereoscopic unit is in a positive correlation with the surface ratio of the second stereoscopic unit.

In one embodiment, a larger surface ratio of the first stereoscopic unit indicates smaller relative protrusion of the first stereoscopic unit. A smaller surface ratio of the first stereoscopic unit indicates larger relative protrusion of the first stereoscopic unit. In one embodiment, a larger surface ratio of the second stereoscopic unit indicates larger relative protrusion of the first stereoscopic unit. A smaller surface ratio of the second stereoscopic unit indicates smaller relative protrusion of the first stereoscopic unit.

In one embodiment, the relative protrusion

$$\frac{{d}_{1}}{{d}_{2}}$$

of the first stereoscopic unit may be calculated by using the foregoing formula “(3)”:

$$\frac{{d}_{1}}{{d}_{2}} = \frac{( 1 - {α}_{1} )}{( 1 - {α}_{2} )} \qquad ( 3 )$$

In sub-operation 734-a, d₂ represents the protrusion degree of the second stereoscopic unit in the direction perpendicular to the outer surface, and is the known reference value. α₁ represents the surface ratio of the first stereoscopic unit. α₂ represents a surface ratio of the second stereoscopic unit.

For example, d₂ is equal to 1.0, α₁ is equal to 0.4, α₂ is equal to 0.5, and the relative protrusion of the first stereoscopic unit is 1.2.

Sub-operation 734-b: The computer device determines protrusion information of the first stereoscopic unit based on the relative protrusion of the first stereoscopic unit.

Because the protrusion degree of the second stereoscopic unit in the direction perpendicular to the outer surface is known, when the relative protrusion between the first stereoscopic unit and the second stereoscopic unit is determined, the protrusion degree of the first stereoscopic unit in the direction perpendicular to the outer surface may also be determined. The protrusion degree of the first stereoscopic unit in the direction perpendicular to the outer surface can be represented by using the relative protrusion of the first stereoscopic unit.

In one embodiment, the computer device determines the relative protrusion of the first stereoscopic unit as the protrusion information of the first stereoscopic unit, or the computer device uses a product of the relative protrusion and the known reference value as the absolute protrusion, and uses the absolute protrusion as the protrusion information of the first stereoscopic unit.

In some embodiments, the method for determining three-dimensional information further includes: determining type information of the at least one stereoscopic unit based on the image, and determining the second stereoscopic unit from the at least one stereoscopic unit based on the type information. The type information is configured for representing a type of a stereoscopic unit, and stereoscopic units of different types have different three-dimensional structures. In one embodiment, the computer device determines a stereoscopic unit whose type information conforms to a preset type as the second stereoscopic unit. The computer device may determine one second stereoscopic unit from the at least one stereoscopic unit, or may determine a plurality of second stereoscopic units from the at least one stereoscopic unit. For example, that the type information conforms to the preset type means that the type information is the same as the preset type.

In some embodiments, after determining the relative protrusion of the first stereoscopic unit, the computer device sets the relative protrusion of the first stereoscopic unit to relative protrusion of a stereoscopic unit of the same type. The stereoscopic unit of the same type is a stereoscopic unit that is in the at least one stereoscopic unit and whose type is the same as that of the first stereoscopic unit. In other words, the stereoscopic unit of the same type and the first stereoscopic unit have the same three-dimensional structure. Inner surfaces of the n stereoscopic units are all in contact with the outer surface of the photographed object, and stereoscopic units of the same type have the same three-dimensional structure. Therefore, this method helps reduce the calculation amount of the computer device.

Compared with the related technology in which a binocular image or a camera intrinsic parameter are needed to determine depth information of a stereoscopic unit in an image, the relative protrusion of the stereoscopic unit in the direction perpendicular to the outer surface is represented by using the relative protrusion, and information for calculating the relative protrusion degree can be directly obtained from the image. This helps reduce an amount of external reference information on which the protrusion degree of the stereoscopic unit predicted based on the image relies, so that the method for determining three-dimensional information is applicable to more scenarios.

The method for determining position information of a stereoscopic unit is described below by using several embodiments.

In some embodiments, in sub-operation 732, that the computer device determines position information of the stereoscopic unit based on the surface ratio of the stereoscopic unit may include the following several operations (not shown in the accompanying drawings of the specification).

Sub-operation 732-a: The computer device determines a vanishing point position based on the frame information of the at least one stereoscopic unit, the vanishing point position being a position of the vanishing point in the image, and the vanishing point being a perspective imaging intersection point of the stereoscopic unit in the image.

For related descriptions of the vanishing point of the image, refer to the foregoing embodiment. Details are not described herein again. For a method for determining the vanishing point position, refer to the following descriptions.

Sub-operation 732-b: The computer device determines, for a first stereoscopic unit in the at least one stereoscopic unit, the first surface position and the second surface position of the first stereoscopic unit based on the vanishing point position and the surface ratio of the first stereoscopic unit, the first surface position being a position of the first surface of the first stereoscopic unit in the image, and the second surface position being a position of the second surface of the first stereoscopic unit in the image.

In some embodiments, the first surface position is configured for positioning the first surface of the stereoscopic unit in the image. For example, when the first surface is a rectangle, first surface positions include positions of four vertexes of the first surface in the image.

For example, when the first surface is a rectangle, the first surface position includes a position of the positioning point of the first surface in the image and size information of the first surface. In this case, the computer device determines the positions of the four vertexes of the first surface in the image based on the position of the positioning point of the first surface in the image and the size information of the first surface. The positioning point includes, but is not limited to: any one of the four vertexes of the first surface and a center point (that is, an intersection point of two diagonal lines) of the first surface.

For example, when the first surface is circular, the first surface position includes a position of a circle center of the first surface in the image and a radius of the first surface. A representation manner of the first surface position is determined based on an actual shape of the first surface. This is not limited in this application herein.

In some embodiments, the second surface position is configured for positioning the second surface of the stereoscopic unit in the image. For example, when the second surface is a rectangle, second surface positions include positions of four vertexes of the second surface in the image.

In some embodiments, that the computer device determines the first surface position and the second surface position of the first stereoscopic unit based on the vanishing point position and the surface ratio of the first stereoscopic unit includes: The computer device determines the first surface position based on frame information of the first stereoscopic unit; the computer device determines a position ratio between the second surface position and the first surface position based on a geometrical relationship between the first surface of the first stereoscopic unit and the second surface of the first stereoscopic unit in the image and the surface ratio of the first stereoscopic unit, the geometrical relationship being determined based on the vanishing point position; and the computer device determines the second surface position based on the position ratio and the first surface position.

In one embodiment, the frame information of the first stereoscopic unit includes the first surface position, the surface ratio, and a center point offset. A value of the center point offset is configured for representing a relative offset degree between the inner surface and the outer surface of the first stereoscopic unit. For example, the first surface positions include the positions of the four vertexes of the first surface in the image, and the computer device directly obtains the first surface position from the frame information of the first stereoscopic unit.

In some embodiments, the geometrical relationship between the first surface of the first stereoscopic unit and the second surface of the first stereoscopic unit in the image is configured for positioning the second surface of the first stereoscopic unit in the image based on a perspective projection relationship.

In one embodiment, the computer device connects a first vertex and the vanishing point on the first surface of the first stereoscopic unit, to obtain a first straight line, and a second vertex of the second surface is on the first straight line, or a second vertex is on a reverse extension line of the first straight line. A frame line exists between the first vertex and the second vertex of the first stereoscopic unit.

In some embodiments, that the computer device determines a position ratio between the second surface position and the first surface position based on a geometrical relationship between the first surface of the first stereoscopic unit and the second surface of the first stereoscopic unit in the image and the surface ratio of the first stereoscopic unit includes: The computer device determines, for any first vertex on the first surface of the first stereoscopic unit, a position of the first vertex in the image based on the first surface position of the first stereoscopic unit; the computer device determines a first distance between the first vertex and the vanishing point in the image based on the position of the first vertex in the image and the vanishing point position; the computer determines a second distance between the second vertex and the vanishing point in the image based on the surface ratio of the first stereoscopic unit and the first distance between the first vertex and the vanishing point; and the computer device uses a ratio between the first distance to the second distance as the position ratio, and the computer device determines a position of the second vertex based on the position of the first vertex in the image, the vanishing point position, and the position ratio. The first vertex in the image is imaging of the first vertex in the image, and the second vertex in the image is imaging of the second vertex in the image.

In one embodiment, when the three-dimensional structure of the first stereoscopic unit is a cube, the first vertex is any vertex on the first surface of the first stereoscopic unit, and the second vertex is a vertex that is on the second surface of the first stereoscopic unit and that is connected to the first vertex by using the frame line.

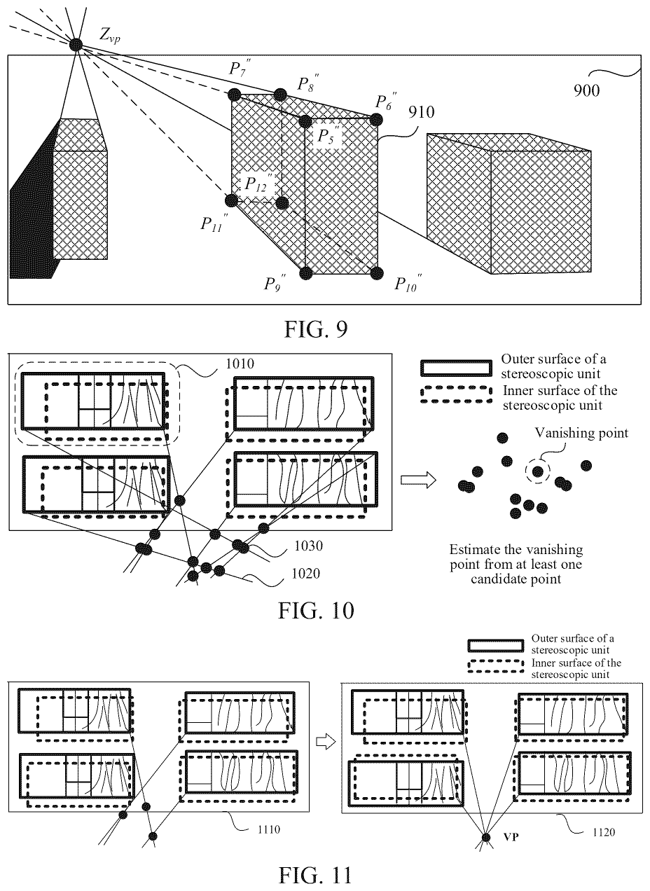

FIG. 9 is a schematic diagram of a process of determining the second surface position according to an exemplary embodiment of this application.

For a first stereoscopic unit 910 in an image 900, positions of four vertexes

$${P}_{5}^{″} , {P}_{6}^{″} , {P}_{9}^{″} , {P}_{10}^{″}$$

of an outer surface of the first stereoscopic unit in the image 900 may be determined by using a first surface position. A vanishing point position of a vanishing point Zᵥₚ is known. It can be learned from a geometrical relationship between a first surface of the first stereoscopic unit 910 and a second surface of the first stereoscopic unit 910 in the image 900 that four vertexes

$${P}_{7}^{″} , {P}_{8}^{″} , {P}_{11}^{″} , {P}_{12}^{″}$$

of an inner surface of the first stereoscopic unit 910 are respectively on straight lines

$${P}_{5}^{″} {Z}_{v p} , {P}_{6}^{″} {Z}_{v p} , {P}_{9}^{″} {Z}_{v p} , {P}_{10}^{″} {Z}_{v p} .$$

Determining a position of

$${P}_{7}^{″}$$

in the image is used as an example. Because

$$Δ {Z}_{vp} {P}_{7}^{″} {P}_{11}^{″} and {ΔZ}_{vp} {P}_{5}^{″} {P}_{9}^{″}$$

are similar triangles,

$$\frac{{P}_{7}^{″} {P}_{11}^{″}}{{P}_{5}^{″} {P}_{9}^{″}} = α ,$$

where α is a surface ratio of the first stereoscopic unit 910.

$${P}_{5}^{″} {P}_{7}^{″} = ( 1 - α ) {Z}_{v p} {P}_{5}^{″} ,$$

so that the position of

$${P}_{7}^{″}$$

in the image can be determined based on positions of

$${P}_{5}^{″} , {Z}_{v p}$$

in the image. Positions of

$${P}_{8}^{″} , {P}_{11}^{″} , {P}_{I 2}^{″}$$

are separately determined by using the same method, to obtain a second surface position of the first stereoscopic unit 910.

A method for determining a second surface position of the first stereoscopic unit 910 is described in FIG. 9 by using an example in which the first surface of the first stereoscopic unit 910 is the outer surface of the first stereoscopic unit 910 and the second surface of the first stereoscopic unit 910 is the inner surface of the first stereoscopic unit 910.

A second surface position of the first stereoscopic unit 910 may alternatively be determined when the first surface of the first stereoscopic unit 910 is the inner surface of the first stereoscopic unit 910 and the second surface of the first stereoscopic unit 910 is the outer surface of the first stereoscopic unit 910. In this case, the position of the vertex

$${P}_{7}^{″}$$

of the inner surface of the first stereoscopic unit 910 in the image is known, and a position of the vertex

$${P}_{5}^{″}$$

of the outer surface of the first stereoscopic unit 910 in the image may be determined based on

$${P}_{5}^{″} {P}_{7}^{″} = ( 1 + α ) {Z}_{v p} {P}_{7}^{″} .$$

In an example, because a distance between the inner surface of the stereoscopic unit and a camera is less than or equal to a distance between the outer surface of the stereoscopic unit and the camera, the outer surface of the stereoscopic unit may block the inner surface of the stereoscopic unit. This causes low accuracy of positioning the inner surface of the stereoscopic unit in the image by the computer device based on the frame information determined from the image. Therefore, the first surface of the first stereoscopic unit may be the outer surface of the first stereoscopic unit.

In another example, the second surface of the first stereoscopic unit may be the inner surface of the first stereoscopic unit. Certainly, when ambient light is dark for photographing, and the first surface has no frame, or the first surface has a weak reflection capability, the first surface of the first stereoscopic unit may be the inner surface of the first stereoscopic unit, and the second surface of the first stereoscopic unit may be the outer surface of the first stereoscopic unit. Whether the first surface is the inner surface or the outer surface of the first stereoscopic unit is set based on an actual requirement. This is not limited in this application.

According to the foregoing method, the first surface position of the first surface of the stereoscopic unit that is relatively accurately positioned in the frame information remains unchanged, and the second surface position of the stereoscopic unit is determined based on the perspective projection principle, the first surface position, the surface ratio, and the vanishing point position. This helps improve accuracy of positioning the first surface and the second surface of the stereoscopic unit in the image based on the position information in the three-dimensional information.

Sub-operation 732-c: The computer device obtains position information of the first stereoscopic unit based on the first surface position and the second surface position.

In some embodiments, that the computer device obtains position information of the first stereoscopic unit based on the first surface position and the second surface position includes: The computer device combines the first surface position and the second surface position to obtain the position information of the first stereoscopic unit. In one embodiment, the position information of the first stereoscopic unit includes the first surface position and the second surface position.

Because the frame information of the stereoscopic unit is obtained through prediction by using the deep learning model or in another manner, and is affected by factors such as identification accuracy and a generalization capability of the deep learning model for the stereoscopic unit, the accuracy of positioning the stereoscopic unit in the image based on the frame information of the stereoscopic unit may be low. According to the foregoing method, the position information of the stereoscopic unit is determined by using the vanishing point in combination with the frame information of the stereoscopic unit. It is equivalent to performing adjustment and optimization on information having low accuracy in the frame information of the stereoscopic unit. This helps improve accuracy of positioning the stereoscopic unit in the image based on the position information of the stereoscopic unit, to represent accuracy of the determined three-dimensional information of the stereoscopic unit.

A method for calculating the vanishing point is described below by using several embodiments.

In some embodiments, in sub-operation 732-a, that the computer device determines a vanishing point position based on the frame information of the at least one stereoscopic unit may include the following several operations.

The computer device determines, for each of the at least one stereoscopic unit, at least one perspective imaging line of the stereoscopic unit in the image based on the frame information of the stereoscopic unit, the perspective imaging line being configured for representing a perspective imaging direction when the stereoscopic unit is photographed; the computer device determines at least one candidate point based on the perspective imaging line of each stereoscopic unit, the candidate point being an intersection point of at least two perspective imaging lines; the computer device determines the vanishing point from the at least one candidate point based on a distance between the candidate point and each perspective imaging line; and the computer device determines the position of the vanishing point in the image as the vanishing point position.

In some embodiments, that the computer device determines at least one perspective imaging line of the stereoscopic unit in the image based on the frame information of the stereoscopic unit includes: The computer device determines positions of the first vertex and the second vertex in the image based on the frame information of the stereoscopic unit; and the computer device determines a straight line passing through the first vertex and the second vertex in the image as the perspective imaging line.

The first vertex is on the first surface of the stereoscopic unit, the second vertex is on the second surface of the stereoscopic unit, and the first vertex and the second vertex are at the same positions on the first surface of the stereoscopic unit and the second surface of the stereoscopic unit. For example, the first vertex is a vertex at a lower left corner of the first surface of the stereoscopic unit, and the second vertex is a vertex at a lower left corner of the second surface of the stereoscopic unit. Coordinates of the first vertex and the second vertex in the image can be determined by using the frame information, and an analysis formula of the perspective imaging line is calculated based on the coordinates of the first vertex and the coordinates of the second vertex, that is, the perspective imaging line is determined.

In one embodiment, the computer device determines, for any one of the at least one stereoscopic unit, p perspective imaging lines of the stereoscopic unit in the image based on the frame information of the stereoscopic unit. p is a positive integer. For example, p is equal to 1, 2, 3, or 4. In one embodiment, for two different stereoscopic units, quantities of perspective imaging lines respectively determined by the computer device based on frame information of the two stereoscopic units may be the same or may be different.

For example, a quantity of perspective imaging lines determined by the computer device based on frame information of the second stereoscopic unit is greater than a quantity of perspective imaging lines determined based on frame information of a non-reference stereoscopic unit. The non-reference stereoscopic unit is a stereoscopic unit in the at least one stereoscopic unit other than the second stereoscopic unit. This method helps improve association between the determined vanishing point position and the second stereoscopic unit, and helps improve accuracy of the relative protrusion determined based on the second stereoscopic unit in the foregoing embodiments.

In some embodiments, that the computer device determines at least one candidate point based on the perspective imaging line of each stereoscopic unit includes: The computer device determines, for any two of the plurality of perspective imaging lines, an intersection point of the two perspective imaging lines, and uses the intersection point as the candidate point.

In some embodiments, that the computer device determines the vanishing point from the at least one candidate point based on a distance between the candidate point and each perspective imaging line includes: The computer device determines the candidate point as the vanishing point if a quantity of neighboring lines of the candidate point satisfies a first condition, the neighboring line being a perspective imaging line whose distance to the candidate point is less than or equal to a first threshold; or the computer device calculates a sum of distances between the candidate point and perspective imaging lines; and the computer device determines the candidate point as the vanishing point if the sum of distances between the candidate point and the perspective imaging lines is less than or equal to a second threshold.

In one embodiment, the first condition is configured for determining the vanishing point based on the quantity of neighboring lines of the candidate point. The first condition includes, but is not limited to, at least one of the following: The quantity of neighboring lines of the candidate point is the largest, and the quantity of neighboring lines of the candidate point is greater than or equal to a third threshold.

In an example, assuming that the at least one candidate point includes a candidate points, and a is a positive integer, the computer device determines b perspective imaging lines based on the frame information of the at least one stereoscopic unit, and b is a positive integer greater than or equal to 2. That the computer device determines the vanishing point from the candidate point based on a distance between the candidate point and each perspective imaging line includes: The computer device determines, for each of the candidate points, a distance between the candidate point and any one of the b perspective imaging lines, to obtain b distances; and the computer device determines a perspective imaging line corresponding to a distance greater than the first threshold in the b distances as a neighboring line of the candidate point, and the computer device counts a quantity of neighboring lines of the candidate point. The computer device selects a candidate point with a largest quantity of neighboring lines as the vanishing point based on quantities of neighboring lines of the candidate points.

In an example, assuming that the at least one candidate point includes c candidate points, and c is a positive integer, the computer device determines d perspective imaging lines based on the frame information of the at least one stereoscopic unit, and d is a positive integer greater than or equal to 2. That the computer device determines the vanishing point from the c candidate point based on a distance between the candidate point and each perspective imaging line includes: The computer device determines distances between a first candidate point in the c candidate points and the d perspective imaging lines, to obtain d distances; the computer device adds the d distances, to obtain a sum of the distances between the first candidate point and the d perspective imaging lines; the computer device determines the candidate point as the vanishing point and selects a candidate point with a largest quantity of neighboring lines as the vanishing point if the sum of the distances between the first candidate point and the d perspective imaging lines is less than or equal to the second threshold; and the computer device deletes the first candidate point from the c candidate points, and determines a first candidate point again from remaining candidate points in the c candidate points if the sum of the distances between the first candidate point and the d perspective imaging lines is greater than or equal to the second threshold. The foregoing operations are repeated until the vanishing point is determined from the c candidate points.

The first threshold and the second threshold are both positive numbers, and specific values of the first threshold and the second threshold are set based on an actual requirement. This is not limited in this application herein.

FIG. 10 is a schematic diagram of a process of determining a vanishing point according to an exemplary embodiment of this application.

As shown in FIG. 10, frame information of a stereoscopic unit 1010 can be configured for positioning positions of an outer surface and an inner surface of the stereoscopic unit 1010 in an image. The computer device determines a perspective imaging line 1020 based on the frame information of the stereoscopic unit 1010. The computer device uses an intersection point 1030 of the perspective imaging line 1020 and another perspective imaging line as a candidate point. After obtaining at least one candidate point, the computer device determines the vanishing point from the at least one candidate point.

The vanishing point is determined by using frame information of each stereoscopic unit, so that in this method, inaccurate information in the frame information can be corrected based on the perspective imaging principle. Therefore, three-dimensional information has a stronger positioning capability for the stereoscopic unit to help improve accuracy of the determined three-dimensional information of the stereoscopic unit.

FIG. 11 is a schematic diagram of comparison between frame information and position information according to an exemplary embodiment of this application.

As shown in FIG. 11, the process of determining the position information is described by using the foregoing embodiments. The computer device determines a vanishing point position, and determines a second surface of a stereoscopic unit (which is the second surface of the stereoscopic unit in this embodiment) based on the vanishing point position, to obtain position information of each stereoscopic unit. In other words, at least one perspective imaging line determined by using the position information of the stereoscopic unit intersects at a vanishing point (VP). Before adjustment is performed by using the vanishing point, there are a plurality of vanishing points of stereoscopic units in an image 1110. After the foregoing adjustment, vanishing points of the stereoscopic units in the image 1120 are unified.

The method for determining frame information of a stereoscopic unit is described below by using several embodiments.

In some embodiments, in operation 720, that the image is processed to obtain frame information of at least one stereoscopic unit may include the following several sub-operations (not shown in the accompanying drawings in the specification).

Sub-operation 722: The computer device crops the image, to obtain a cropped image including the at least one stereoscopic unit.

In some embodiments, because the image includes a plurality of stereoscopic units, to reduce a calculation amount of the computer device in an image processing process, the image needs to be cropped, so that a quantity of stereoscopic units included in the cropped image is less than a quantity of stereoscopic units included in the image, that is, a quantity of stereoscopic units whose three-dimensional information needs to be determined is reduced.

In some embodiments, in sub-operation 722, that the computer device crops the image, to obtain a cropped image including the at least one stereoscopic unit includes: The computer device obtains cropped area information for the image, the cropped area information including positions of four cropped vertexes of the cropped image in the image; and the computer device deletes, from the image, an area other than a cropped area obtained by connecting the four cropped vertexes, to obtain the cropped image.

In some embodiments, the cropped area information includes coordinates of the four cropped vertexes of the cropped image in the image. In one embodiment, the coordinates of the four cropped vertexes of the cropped image in the image are manually determined, to obtain the cropped area information.

In one embodiment, the cropped area information is marked by using a machine. For example, the computer device inputs the image into a cropped area determining model, and the cropped area determining model identifies the stereoscopic unit from the image and obtains the cropped area information through calculation based on an imaging area of the stereoscopic unit in the image. For example, after identifying m stereoscopic units from the image, the cropped area determining model determines imaging areas of the m stereoscopic units in the image, and determines a smallest area in the imaging areas including the m stereoscopic units in the image as the cropped area. The cropped area determining model is any model that can complete image identification. A type of the cropped area determining model is not limited in this application.

For example, the computer device deletes an area other than the cropped area obtained by connecting the four cropped vertexes in the image, to obtain that the cropped image includes m stereoscopic units, m being a positive integer. Because perspective distortion exists, the cropped image may be an irregular quadrangle.

Sub-operation 724: The computer device performs perspective transformation on the cropped image, to obtain a corrected image, a shape of the first surface of the stereoscopic unit in the corrected image being the same as a shape of the first surface in the three-dimensional structure of the stereoscopic unit.

In some embodiments, in sub-operation 724, that the computer device performs perspective transformation on the cropped image, to obtain a corrected image includes: The computer device determines area information of the corrected image based on area information of the cropped image, the area information of the cropped image being configured for representing positions of four vertexes of the cropped image in the image, and the area information of the corrected image being configured for representing positions of four vertexes of the corrected image in the image; the computer device calculates a transformation matrix based on the area information of the cropped image and the area information of the corrected image, the transformation matrix being configured for transforming a pixel in the cropped image into a pixel in the corrected image; the computer device determines, for each pixel in the cropped image, a position of the pixel in the corrected image based on a position of the pixel in the cropped image and the transformation matrix; and the computer device arranges pixels based on the position of each pixel in the corrected image, to obtain the corrected image.

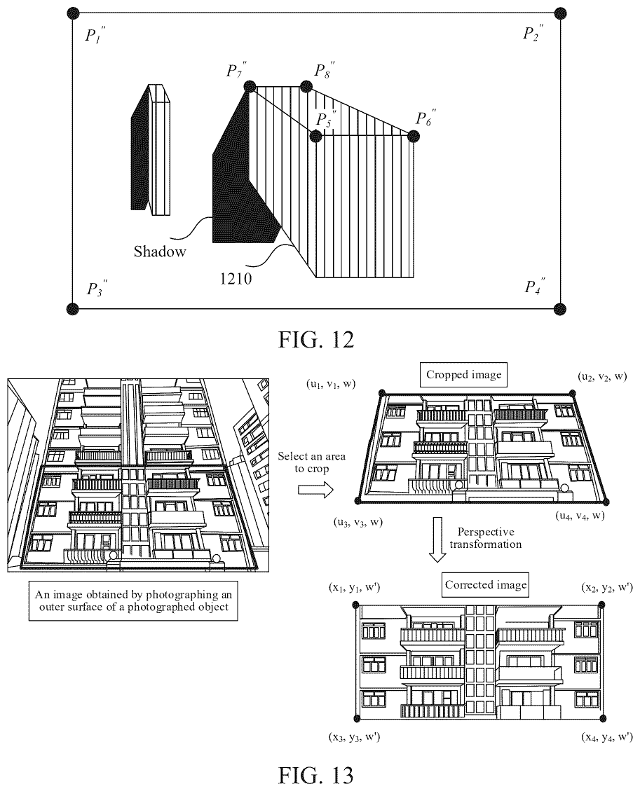

FIG. 12 is a schematic diagram of a corrected stereoscopic unit according to an exemplary embodiment of this application. The corrected image represents perspective imaging when the outer surface of the photographed object is parallel to the imaging plane. As shown in FIG. 12, a plane

$${P}_{1}^{″} {P}_{2}^{″} {P}_{4}^{″} {P}_{3}^{″}$$

represents the outer surface of the photographed object, and the outer surface of the photographed object is parallel to the imaging plane. A three-dimensional structure of a stereoscopic unit 1210 is a cuboid. In the corrected image, an upper surface

$${P}_{5}^{″} {P}_{6}^{″} {P}_{7}^{″} {P}_{8}^{″}$$

of the stereoscopic unit 1210 is perpendicular to the outer surface

$${P}_{1}^{″} {P}_{2}^{″} {P}_{4}^{″} {P}_{3}^{″}$$

of the photographed object.

In subsequent frame information of the stereoscopic unit determined by using the corrected image, the frame information is configured for positioning the stereoscopic unit in the corrected image. Because the corrected image is equivalent to an image photographed when the perspective imaging plane is parallel to the outer surface, the frame information may also be configured for positioning an actual position of the stereoscopic unit on the outer surface.

In some embodiments, the corrected image is a rectangle. In one embodiment, a shape of the corrected image is a circumscribed quadrangle of a shape of the cropped image. The computer device determines a largest horizontal coordinate, a smallest horizontal coordinate, a largest vertical coordinate, and a smallest vertical coordinate from the area information of the cropped image. The computer device combines the largest horizontal coordinate, the smallest horizontal coordinate, the largest vertical coordinate, and the smallest vertical coordinate based on that the shape of the corrected image is a circumscribed quadrangle of a shape of the cropped image, to obtain the area information of the corrected image.

FIG. 13 is a schematic diagram of image cropping and correction according to an exemplary embodiment of this application.

As shown in FIG. 13, the computer device crops the image obtained by photographing the outer surface of the photographed object, to obtain the cropped image. The computer device performs perspective correction on the cropped image, to obtain the corrected image. An operation of cropping and correction is performed to retain a truly needed image and remove distortion caused by photographing, so that the stereoscopic unit can be better detected and identified from the corrected image subsequently.

In some embodiments, a position of a point in the image may be represented by using two-dimensional coordinates. A horizontal coordinate represents a position of the point in a horizontal direction in the image, and a vertical coordinate represents a position of the point in a vertical direction in the image. During perspective transformation, to ensure that parameters in a transformation matrix can be solved, a new dimension is added to the coordinates of the point in the image, and a coordinate value of any point in the cropped image on the dimension is fixed, for example, is equal to 1.

In an example, homogeneous coordinates of four vertexes of the cropped image in the image are respectively (uᵢ, vᵢ, w) (i=1,2,3,4), where w=1.Homogeneous coordinates of four vertexes of the corrected image are respectively (xᵢ, yᵢ, w′) (i=1,2,3,4), and it is assumed that w′=1.

A common transformation formula of perspective transformation is:

$$[ x , y , {w}^{′} ] = [ u , v , w ] [ \begin{matrix}{a}_{11} & {a}_{12} & {a}_{13} \\ {a}_{21} & {a}_{22} & {a}_{23} \\ {a}_{3 I} & {a}_{32} & {a}_{33}\end{matrix} ] .$$

[u, v, w] is a position of a vertex of the cropped image in the image. [x, y, w′] is a position of a vertex of the corrected image in the image, and

$$[ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

is a transformation matrix. The coordinates of the four vertexes of the cropped image and the coordinates of the four vertexes of the corrected image are substituted into the common transformation formula, to obtain eight equations.

$$\{ \begin{matrix}{x}_{i} = \frac{{a}_{11} {u}_{i} + {a}_{21} {v}_{i} + {a}_{31}}{{a}_{13} {u}_{i} + {a}_{23} {v}_{i} + {a}_{33}} \\ {y}_{i} = \frac{{a}_{12} {u}_{i} + {a}_{22} {v}_{i} + {a}_{32}}{{a}_{13} {u}_{i} + {a}_{23} {v}_{i} + {a}_{33}}\end{matrix} ( i = 1 , 2 , 3 , 4 )$$

Values of the parameters in the transformation matrix may be calculated by solving a simultaneous equation of the foregoing eight equations, to obtain the transformation matrix. Subsequently, the computer device determines a position of each pixel in the cropped image in the corrected image based on the transformation matrix and the common transformation formula.

Distortion correction is performed on the image, to help reduce deformation of the stereoscopic unit in the image caused by perspective distortion, and help improve accuracy of the determined frame information of the stereoscopic unit.

Sub-operation 726: The computer device processes the corrected image, to obtain the frame information of the at least one stereoscopic unit.

In some embodiments, in operation 726, that the computer device processes the corrected image, to determine the frame information of the at least one stereoscopic unit may include the following several sub-operations (not shown in the accompanying drawings in the specification).

Sub-operation 726-a: The computer device performs feature extraction on the corrected image by using a feature extraction layer of the frame detection model, to obtain feature information of the corrected image.

In some embodiments, the frame detection model is a deep learning model, and is configured to identify, from the image, a frame of the stereoscopic unit, or the frame information of the stereoscopic unit. For example, the frame detection model uses a structure of a Faster regions with CNN features (RCNN) model.

For example, feature extraction layers (Conv layers) include a convolutional (conv) layer, an activation (relu) layer, and a pooling (pooling) layer. A frame identification layer extracts the feature information from a calibration vector through convolution, activation, and pooling. The feature information is also referred to as a feature map, and the feature information is shared by a subsequent layer structure in the frame detection model.

Sub-operation 726-b: The computer device performs processing based on the feature information by using the frame identification layer of the frame detection model, to determine at least one target area of the corrected image, the target area indicating an area in which the stereoscopic unit is displayed in the corrected image.

The frame identification layer is also referred to as a region proposal network, and is configured to detect the target area in the corrected image. In one embodiment, the frame identification layer processes the feature information based on softmax, determines whether a stereoscopic unit is displayed in a plurality of preset anchor areas in the corrected image, and then adjusts a frame of the anchor area through frame correction, to obtain a precise target area (proposals). For example, a vertex position of the anchor area in the corrected image is determined. Usually, the anchor area may be understood as a rectangle box. The plurality of anchor areas refers to a plurality of rectangle boxes with different sizes.

Sub-operation 726-c: The computer device determines at least one piece of unit feature information by using the pooling layer of the frame detection model and based on the at least one target area and the feature information. The unit feature information is configured for representing the feature information of the stereoscopic unit. The pooling layer is also referred to as Roi pooling.

Sub-operation 726-d. The computer device performs linear mapping on the feature information of each unit by using a linear mapping layer of the frame detection model, to obtain the frame information of the at least one stereoscopic unit.

In one embodiment, the frame information of the stereoscopic unit includes an outer surface position (Outer Box) of the stereoscopic unit, a center offset from a forward direction of the outer surface to a center of the inner surface, and a size ratio of the inner surface (Inner Scale) relative to the outer surface.

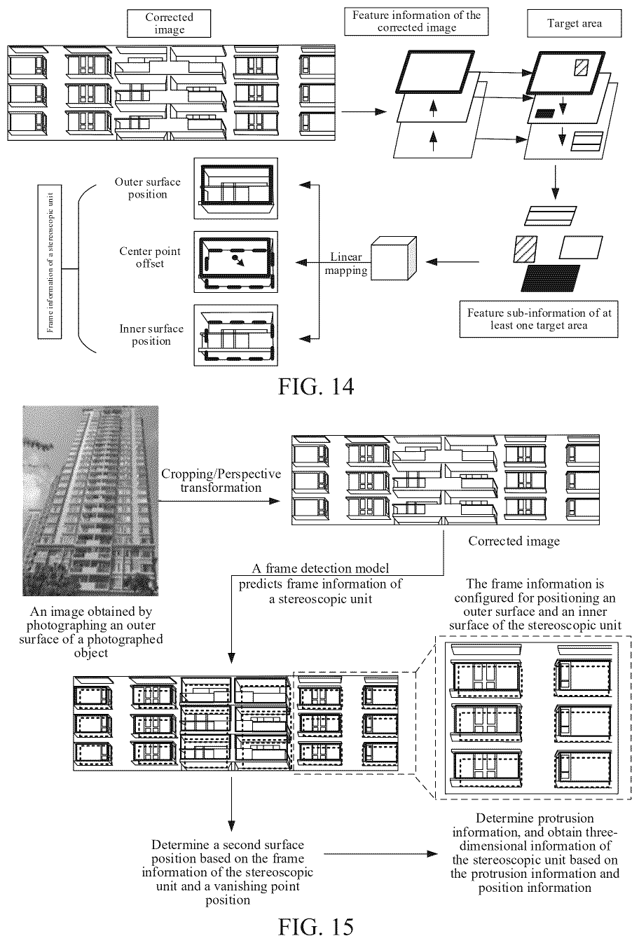

FIG. 14 is a schematic diagram of a process of determining frame information according to an exemplary embodiment of this application.

The computer device inputs a corrected building body into the frame detection model, and then performs feature extraction on the corrected image by using the feature extraction layer of the frame detection model, to obtain the feature information of the corrected image. The computer device performs processing based on the feature information and by using the frame identification layer of the frame detection model, to determine the at least one target area of the corrected image. The computer device determines at least one piece of unit feature information by using the pooling layer of the frame detection model and based on the at least one target area and the feature information. The computer device performs linear mapping on the feature information of each unit by using the linear mapping layer of the frame detection model, to obtain the frame information of the at least one stereoscopic unit.

FIG. 15 is a schematic diagram of a method for determining three-dimensional information according to an exemplary embodiment of this application.

A computer device obtains an image obtained by photographing an outer surface of a photographed object; the computer device crops the image, to obtain a cropped image including at least one stereoscopic unit; and the computer device performs perspective transformation on the cropped image, to obtain a corrected image. Subsequently, the computer device processes the corrected image by using a frame detection model, to obtain frame information of the at least one stereoscopic unit. The computer device determines a vanishing point position based on the frame information of the at least one stereoscopic unit, determines a second surface position of each stereoscopic unit based on the vanishing point position and the frame information, and determines protrusion information of the stereoscopic unit based on a surface ratio in the frame information. The computer device determines three-dimensional information of the stereoscopic unit based on a first surface position, the second surface position, and the protrusion information.

The following describes the method for determining three-dimensional information of a building unit by using an example in which the photographed object is a building and the stereoscopic unit is a building unit. This example includes the following several operations.

Operation A10: The computer device obtains the image obtained by photographing the outer surface of the photographed object.

In this example, the photographed object is the building, and the outer surface of the photographed object is an outer facade of the building. The stereoscopic unit is the building unit. For example, the building unit includes, but is not limited to, a three-dimensional structure protruding from the outer facade of the building, such as a floating window, a balcony, and an archway.

Operation A20: The computer device crops the image, to obtain a cropped image including at least one building unit. In one embodiment, information about a cropped area configured for cropping the image may be manually marked, or may be automatically identified by a machine.

Operation A30: The computer device performs perspective transformation on the cropped image, to obtain a corrected image. A shape of a first surface of the building unit in the corrected image is the same as a shape of a first surface in a three-dimensional structure of the building unit.

Operation A40: Process the corrected image, to obtain frame information of the at least one building unit.

In one embodiment, that the computer device processes the corrected image by using a frame detection model may specifically include the following several operations: performing feature extraction on the corrected image by using a feature extraction layer of the frame detection model, to obtain feature information of the corrected image; performing processing by using a frame identification layer of the frame detection model and based on the feature information, to determine at least one target area of the corrected image; determining at least one piece of unit feature information by using a pooling layer of the frame detection model and based on the at least one target area and the feature information; and performing linear mapping on each unit feature information by using a linear mapping layer of the frame detection model, to obtain the frame information of the at least one building unit.

Operation A50: The corrected image includes a plurality of building units. The computer device determines, for a first building unit in the plurality of building units included in the image, relative protrusion of the first building unit based on a surface ratio of the first building unit and a surface ratio of a second building unit; and the computer device determines protrusion information of the first building unit based on the relative protrusion of the first building unit.

Operation A60: The computer device determines a vanishing point position based on the frame information of the at least one building unit.

Operation A70: The computer device determines, for the first building unit in the at least one building unit, a first surface position and a second surface position of the first building unit based on the vanishing point position and the surface ratio of the first building unit; and the computer device obtains position information of the first building unit based on the first surface position and the second surface position.

Operation A80: The computer device obtains three-dimensional information of the building unit based on the position information of the building unit and the protrusion information of the building unit.

For a part not described in detail in this embodiment, refer to the foregoing embodiments. Details are not described herein again.

The method for determining three-dimensional information provided in this application may further be configured for determining three-dimensional information of another type of stereoscopic unit. For example, in an exemplary application scenario, the photographed object is the ground, the stereoscopic unit is a building in a site, the image is an image photographed in a top view of the ground, the protrusion degree represents a height of the building on the ground, and three-dimensional information of the building determined in the scenario may be applied to three-dimensional environment construction of an electronic map.

In another exemplary application scenario, the photographed object is a road, the image is a ground image obtained through aerial photographing, the stereoscopic unit is a vehicle on the road, the protrusion degree represents a height of the vehicle, and three-dimensional information of the vehicle determined in the scenario may be applied to three-dimensional environment construction in an assisted driving or autonomous driving scenario. Specific operations of the method for determining three-dimensional information of a stereoscopic unit in these scenarios are similar to the method for determining three-dimensional information of a building unit in this example. Details are not described herein again.

The following describes apparatus embodiments of this application that can be configured for executing the method embodiments of this application. For details not disclosed in the apparatus embodiments of this application, refer to the method embodiments of this application.

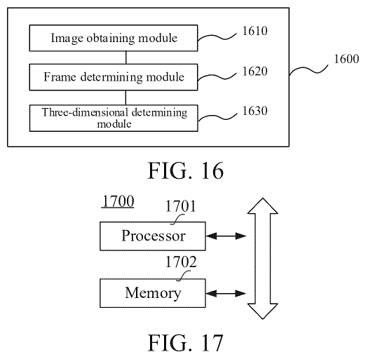

FIG. 16 is a block diagram of an apparatus for determining three-dimensional information according to an exemplary embodiment of this application. The apparatus may be implemented as all or a part of a device for determining three-dimensional information through software, hardware, or a combination thereof. The apparatus 1600 may include an image obtaining module 1610, a frame determination module 1620, and a three-dimensional determining module 1630.

The image obtaining module 1610 is configured to obtain an image obtained by photographing an outer surface of a photographed object, the outer surface of the photographed object having n protruding stereoscopic units, the stereoscopic unit being a physical unit having a three-dimensional structure, and n being a positive integer.

The frame determination module 1620 is configured to process the image, to obtain frame information of at least one stereoscopic unit, the frame information being configured for positioning a first surface and a second surface of the stereoscopic unit in the image, the first surface being parallel to the second surface, and the first surface or the second surface being in the outer surface.

The three-dimensional determining module 1630 is configured to determine three-dimensional information of the stereoscopic unit based on the frame information of the stereoscopic unit, the three-dimensional information being configured for representing a position of the stereoscopic unit in the image and a protrusion degree of the stereoscopic unit in a direction perpendicular to the outer surface.

In some embodiments, the frame information includes a surface ratio, and the surface ratio is configured for representing a size ratio between the first surface and the second surface in the image. The three-dimensional determining module 1630 includes a position determining submodule, configured to determine position information of the stereoscopic unit based on the surface ratio of the stereoscopic unit, the position information being configured for representing the position of the stereoscopic unit in the image; a protrusion determining submodule, configured to determine protrusion information of the stereoscopic unit based on the surface ratio of the stereoscopic unit, the protrusion information being configured for representing the protrusion degree of the stereoscopic unit in the direction perpendicular to the outer surface; and a three-dimensional determining submodule, configured to obtain the three-dimensional information of the stereoscopic unit based on the position information of the stereoscopic unit and the protrusion information of the stereoscopic unit.

In some embodiments, the image includes a plurality of stereoscopic units, the plurality of stereoscopic units includes a first stereoscopic unit and a second stereoscopic unit, and a protrusion degree of the second stereoscopic unit in the direction perpendicular to the outer surface is a known reference value. The protrusion determining submodule is configured to determine relative protrusion of the first stereoscopic unit based on a surface ratio of the first stereoscopic unit and a surface ratio of the second stereoscopic unit, the relative protrusion of the first stereoscopic unit being configured for representing a protrusion degree of the first stereoscopic unit relative to the second stereoscopic unit in the direction perpendicular to the outer surface; and determine protrusion information of the first stereoscopic unit based on the relative protrusion of the first stereoscopic unit.

In some embodiments, the relative protrusion of the first stereoscopic unit is in a negative correlation with the surface ratio of the first stereoscopic unit. The relative protrusion of the first stereoscopic unit is in a positive correlation with the surface ratio of the second stereoscopic unit.

In some embodiments, the position determining submodule includes a vanishing point determining unit, configured to determine a vanishing point position based on the frame information of the at least one stereoscopic unit, the vanishing point position being a position of a vanishing point in the image, and the vanishing point being a perspective imaging intersection point of the stereoscopic unit in the image; a position calculation unit, configured to determine, for a first stereoscopic unit in the at least one stereoscopic unit, a first surface position and a second surface position of the first stereoscopic unit based on the vanishing point position and a surface ratio of the first stereoscopic unit, the first surface position being a position of a first surface of the first stereoscopic unit in the image, and the second surface position being a position of a second surface of the first stereoscopic unit in the image; a position determining unit, configured to obtain position information of the first stereoscopic unit based on the first surface position and the second surface position.

In some embodiments, the position calculation unit is configured to determine the first surface position based on frame information of the first stereoscopic unit; determine a position ratio between the second surface position and the first surface position based on a geometrical relationship between the first surface of the first stereoscopic unit and the second surface of the first stereoscopic unit in the image and the surface ratio of the first stereoscopic unit, the geometrical relationship being determined based on the vanishing point position; and determine the second surface position based on the position ratio and the first surface position.

In some embodiments, the vanishing point determining unit includes a line determining subunit, configured to: determine, for each of the at least one stereoscopic unit, at least one perspective imaging line of the stereoscopic unit in the image based on the frame information of the stereoscopic unit, the perspective imaging line being configured for representing a perspective imaging direction when the stereoscopic unit is photographed; a candidate point determining subunit, configured to determine at least one candidate point based on the perspective imaging line of each stereoscopic unit, the candidate point being an intersection point of at least two perspective imaging lines; a vanishing point determining subunit, configured to determine the vanishing point from the at least one candidate point based on a distance between the candidate point and each perspective imaging line; and a position determining subunit, configured to determine the position of the vanishing point in the image as the vanishing point position.

In some embodiments, the vanishing point determining subunit is configured to determine the candidate point as the vanishing point if a quantity of neighboring lines of the candidate point satisfies a first condition, the neighboring line being a perspective imaging line whose distance to the candidate point is less than or equal to a first threshold; or calculate a sum of distances between the candidate point and perspective imaging lines; and determine the candidate point as the vanishing point if the sum of distances between the candidate point and the perspective imaging lines is less than or equal to a second threshold.

In some embodiments, the frame determining module 1620 includes a cropping submodule, configured to crop the image, to obtain a cropped image including the at least one stereoscopic unit; and a transformation submodule, configured to perform perspective transformation on the cropped image, to obtain a corrected image, a shape of the first surface of the stereoscopic unit in the corrected image being the same as a shape of the first surface in the three-dimensional structure of the stereoscopic unit; and a frame determining submodule, configured to process the corrected image, to obtain the frame information of the at least one stereoscopic unit.

In some embodiments, the frame determining submodule is configured to: perform feature extraction on the corrected image by using a feature extraction layer of a frame detection model, to obtain feature information of the corrected image; perform processing by using a frame identification layer of the frame detection model and based on the feature information, to determine at least one target area of the corrected image, the target area indicating an area in which the stereoscopic unit is displayed in the corrected image; determine at least one piece of unit feature information by using a pooling layer of the frame detection model and based on the at least one target area and the feature information, the unit feature information being configured for representing feature information of the stereoscopic unit; and perform linear mapping on each piece of unit feature information by using a linear mapping layer of the frame detection model, to obtain the frame information of the at least one stereoscopic unit.

In some embodiments, the transformation submodule is configured to determine area information of the corrected image based on area information of the cropped image, the area information of the cropped image being configured for representing positions of four vertexes of the cropped image in the image, and the area information of the corrected image being configured for representing positions of four vertexes of the corrected image in the image; calculate a transformation matrix based on the area information of the cropped image and the area information of the corrected image, the transformation matrix being configured for transforming a pixel in the cropped image into a pixel in the corrected image; determine, for each pixel in the cropped image, a position of the pixel in the corrected image based on a position of the pixel in the cropped image and the transformation matrix; and arrange pixels based on the position of each pixel in the corrected image, to obtain the corrected image.

In some embodiments, the cropping submodule is configured to obtain cropped area information for the image, the cropped area information including positions of four cropped vertexes of the cropped image in the image; and delete, from the image, an area other than a cropped area obtained by connecting the four cropped vertexes, to obtain the cropped image.

When the apparatus provided in the foregoing embodiments implements functions of the apparatus, the division of the foregoing functional modules is merely an example for description. During actual application, the functions may be assigned to and completed by different functional modules according to the requirements, that is, a content structure of the device is divided into different functional modules, to implement all or some of the functions described above. In addition, the apparatus and method embodiments provided in the foregoing embodiments belong to the same idea. For a specific implementation process, refer to the method embodiments. Details are not described herein again. For beneficial effects of the apparatus provided in the foregoing embodiments, refer to the descriptions of the method side embodiments. Details are not described herein again.

FIG. 17 is a structural block diagram of a computer device according to an exemplary embodiment of this application. A device 1700 for determining three-dimensional information may be the computer device described above.

Usually, the computer device 1700 includes a processor 1701 and a memory 1702.

The processor 1701 may include one or more processing cores, for example, a 4-core processor or a 17-core processor. The processor 1701 may be implemented in at least one hardware form of a digital signal processor (DSP), a field programmable gate array (FPGA), and a programmable logic array (PLA). The processor 1701 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1701 may be integrated with a graphics processing unit (GPU). The GPU is configured to render and draw content that needs to be displayed on a display screen. In some embodiments, the processor 1701 may further include an artificial intelligence (AI) processor. The AI processor is configured to process computing operations related to machine learning.

The memory 1702 may include one or more computer-readable storage media. The computer-readable storage media may be tangible and non-transitory. The memory 1702 may further include a high-speed random access memory and a non-volatile memory, such as one or more disk storage devices and flash storage devices. In some embodiments, the non-transitory computer-readable storage medium in the memory 1702 has at least one segment of computer program stored therein, and the at least one segment of computer program is loaded and executed by the processor 1701 to implement the foregoing method for determining three-dimensional information according to the foregoing method embodiments.

An embodiment of this application further provides a computer-readable storage medium, the storage medium having a computer program stored therein, and the computer program being loaded and executed by a processor to implement the method for determining three-dimensional information according to the foregoing method embodiments.

The computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a random access memory (RAM), a read-only memory (ROM), an erasable programmable ROM (EPROM), an electrically erasable programmable ROM (EEPROM), a flash memory or another solid-state memory technology, a digital video disc (DVD) or another optical memory, a tape cartridge, a magnetic tape, a magnetic disk memory, or another magnetic storage device. Certainly, a person skilled in the art can learn that the computer storage medium is not limited to the foregoing several types.

An embodiment of this application further provides a computer program product. The computer program product includes a computer program, the computer program is stored in a computer-readable storage medium, and a processor reads the computer program from the computer-readable storage medium and executes the computer program, to implement the foregoing method for determining three-dimensional information according to the foregoing method embodiments.

“A plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

In this application, before related data of a user is collected and in a process of collecting the related data of the user, a prompt interface, a pop-up window, or voice prompt information may be displayed. The prompt interface, the pop-up window, or the voice prompt information is configured for prompting the user that the related data of the user is being collected. Therefore, in this application, only after a confirmation operation transmitted by the user to the prompt interface or the pop-up window is obtained, a related operation of obtaining the related data of the user starts to be performed, and otherwise (in other words, when the confirmation operation transmitted by the user to the prompt interface or the pop-up window is not obtained), the related operation of obtaining the related data of the user ends, that is, the related data of the user is not obtained. In other words, all images obtained by photographing the outer surface of the photographed object in this application are collected with the informed consent or separate consent of the personal information subject according to the requirements of relevant national laws and regulations, and only after the consent and authorization of the user. Subsequent data usage and processing activities are carried out within the scope of laws and regulations and the authorization of the personal information subject. The collection, use and processing of relevant user data needs to comply with the relevant laws, regulations and standards of the respective countries and regions.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for determining three-dimensional information of an object performed by a computer device, the method comprising:
obtaining an image of an outer surface of a photographed object, the outer surface of the photographed object having n protruding stereoscopic units, and n being a positive integer;
processing the image, to obtain frame information of at least one stereoscopic unit, the frame information including a first surface and a second surface of the stereoscopic unit in the image, the first surface being parallel to the second surface; and
determining three-dimensional information of the stereoscopic unit based on the frame information of the stereoscopic unit, the three-dimensional information representing a position of the stereoscopic unit in the image and a protrusion degree of the stereoscopic unit in a direction perpendicular to the outer surface.

2. The method according to claim 1, wherein the frame information comprises a surface ratio representing a size ratio between the first surface and the second surface in the image; and
the determining three-dimensional information of the stereoscopic unit based on the frame information of the stereoscopic unit comprises:
determining position information of the stereoscopic unit based on the surface ratio of the stereoscopic unit, the position information representing the position of the stereoscopic unit in the image;
determining protrusion information of the stereoscopic unit based on the surface ratio of the stereoscopic unit, the protrusion information representing the protrusion degree of the stereoscopic unit in the direction perpendicular to the outer surface; and
obtaining the three-dimensional information of the stereoscopic unit based on the position information of the stereoscopic unit and the protrusion information of the stereoscopic unit.

3. The method according to claim 2, wherein the image comprises a first stereoscopic unit and a second stereoscopic unit, and a protrusion degree of the second stereoscopic unit in the direction perpendicular to the outer surface is a known reference value; and
the determining protrusion information of the stereoscopic unit based on the surface ratio of the stereoscopic unit comprises:
determining relative protrusion of the first stereoscopic unit based on a surface ratio of the first stereoscopic unit and a surface ratio of the second stereoscopic unit, the relative protrusion of the first stereoscopic unit being configured for representing a protrusion degree of the first stereoscopic unit relative to the second stereoscopic unit in the direction perpendicular to the outer surface; and
determining protrusion information of the first stereoscopic unit based on the relative protrusion of the first stereoscopic unit.

4. The method according to claim 3, wherein
the relative protrusion of the first stereoscopic unit is in a negative correlation with the surface ratio of the first stereoscopic unit; and
the relative protrusion of the first stereoscopic unit is in a positive correlation with the surface ratio of the second stereoscopic unit.

5. The method according to claim 2, wherein the determining position information of the stereoscopic unit based on the surface ratio of the stereoscopic unit comprises:
determining a vanishing point position based on the frame information of the at least one stereoscopic unit, the vanishing point position being a position of a vanishing point in the image, and the vanishing point being a perspective imaging intersection point of the stereoscopic unit in the image;
determining, for a first stereoscopic unit in the at least one stereoscopic unit, a first surface position and a second surface position of the first stereoscopic unit based on the vanishing point position and a surface ratio of the first stereoscopic unit, the first surface position being a position of a first surface of the first stereoscopic unit in the image, and the second surface position being a position of a second surface of the first stereoscopic unit in the image; and
obtaining position information of the first stereoscopic unit based on the first surface position and the second surface position.

6. The method according to claim 5, wherein the determining a first surface position and a second surface position of the first stereoscopic unit based on the vanishing point position and a surface ratio of the first stereoscopic unit comprises:
determining the first surface position based on frame information of the first stereoscopic unit;
determining a position ratio between the second surface position and the first surface position based on a geometrical relationship between the first surface of the first stereoscopic unit and the second surface of the first stereoscopic unit in the image and the surface ratio of the first stereoscopic unit, the geometrical relationship being determined based on the vanishing point position; and
determining the second surface position based on the position ratio and the first surface position.

7. The method according to claim 5, wherein the determining a vanishing point position based on the frame information of the at least one stereoscopic unit comprising:
determining, for each of the at least one stereoscopic unit, at least one perspective imaging line of the stereoscopic unit in the image based on the frame information of the stereoscopic unit, the perspective imaging line being configured for representing a perspective imaging direction when the stereoscopic unit is photographed;
determining at least one candidate point based on the perspective imaging line of each stereoscopic unit, the candidate point being an intersection point of at least two perspective imaging lines;
determining the vanishing point from the at least one candidate point based on a distance between the candidate point and each perspective imaging line; and
determining the position of the vanishing point in the image as the vanishing point position.

8. The method according to claim 1, wherein the processing the image, to obtain frame information of at least one stereoscopic unit comprises:
cropping the image, to obtain a cropped image comprising the at least one stereoscopic unit;
performing perspective transformation on the cropped image, to obtain a corrected image, a shape of the first surface of the stereoscopic unit in the corrected image being the same as a shape of the first surface in the three-dimensional structure of the stereoscopic unit; and
processing the corrected image, to obtain the frame information of the at least one stereoscopic unit.

9. A computer device, comprising a processor and a memory, the memory having a computer program stored therein, and the computer program, when being loaded and executed by the processor, causing the computer device to implement a method for determining three-dimensional information of an object including:
obtaining an image of an outer surface of a photographed object, the outer surface of the photographed object having n protruding stereoscopic units, and n being a positive integer;
processing the image, to obtain frame information of at least one stereoscopic unit, the frame information including a first surface and a second surface of the stereoscopic unit in the image, the first surface being parallel to the second surface; and
determining three-dimensional information of the stereoscopic unit based on the frame information of the stereoscopic unit, the three-dimensional information representing a position of the stereoscopic unit in the image and a protrusion degree of the stereoscopic unit in a direction perpendicular to the outer surface.

10. The computer device according to claim 9, wherein the frame information comprises a surface ratio representing a size ratio between the first surface and the second surface in the image; and
the determining three-dimensional information of the stereoscopic unit based on the frame information of the stereoscopic unit comprises:
determining position information of the stereoscopic unit based on the surface ratio of the stereoscopic unit, the position information representing the position of the stereoscopic unit in the image;
determining protrusion information of the stereoscopic unit based on the surface ratio of the stereoscopic unit, the protrusion information representing the protrusion degree of the stereoscopic unit in the direction perpendicular to the outer surface; and
obtaining the three-dimensional information of the stereoscopic unit based on the position information of the stereoscopic unit and the protrusion information of the stereoscopic unit.

11. The computer device according to claim 10, wherein the image comprises a first stereoscopic unit and a second stereoscopic unit, and a protrusion degree of the second stereoscopic unit in the direction perpendicular to the outer surface is a known reference value; and
the determining protrusion information of the stereoscopic unit based on the surface ratio of the stereoscopic unit comprises:
determining relative protrusion of the first stereoscopic unit based on a surface ratio of the first stereoscopic unit and a surface ratio of the second stereoscopic unit, the relative protrusion of the first stereoscopic unit being configured for representing a protrusion degree of the first stereoscopic unit relative to the second stereoscopic unit in the direction perpendicular to the outer surface; and
determining protrusion information of the first stereoscopic unit based on the relative protrusion of the first stereoscopic unit.

12. The computer device according to claim 11, wherein
the relative protrusion of the first stereoscopic unit is in a negative correlation with the surface ratio of the first stereoscopic unit; and
the relative protrusion of the first stereoscopic unit is in a positive correlation with the surface ratio of the second stereoscopic unit.

13. The computer device according to claim 10, wherein the determining position information of the stereoscopic unit based on the surface ratio of the stereoscopic unit comprises:
determining a vanishing point position based on the frame information of the at least one stereoscopic unit, the vanishing point position being a position of a vanishing point in the image, and the vanishing point being a perspective imaging intersection point of the stereoscopic unit in the image;
determining, for a first stereoscopic unit in the at least one stereoscopic unit, a first surface position and a second surface position of the first stereoscopic unit based on the vanishing point position and a surface ratio of the first stereoscopic unit, the first surface position being a position of a first surface of the first stereoscopic unit in the image, and the second surface position being a position of a second surface of the first stereoscopic unit in the image; and
obtaining position information of the first stereoscopic unit based on the first surface position and the second surface position.

14. The computer device according to claim 13, wherein the determining a first surface position and a second surface position of the first stereoscopic unit based on the vanishing point position and a surface ratio of the first stereoscopic unit comprises:
determining the first surface position based on frame information of the first stereoscopic unit;
determining a position ratio between the second surface position and the first surface position based on a geometrical relationship between the first surface of the first stereoscopic unit and the second surface of the first stereoscopic unit in the image and the surface ratio of the first stereoscopic unit, the geometrical relationship being determined based on the vanishing point position; and
determining the second surface position based on the position ratio and the first surface position.

15. The computer device according to claim 13, wherein the determining a vanishing point position based on the frame information of the at least one stereoscopic unit comprising:
determining, for each of the at least one stereoscopic unit, at least one perspective imaging line of the stereoscopic unit in the image based on the frame information of the stereoscopic unit, the perspective imaging line being configured for representing a perspective imaging direction when the stereoscopic unit is photographed;
determining at least one candidate point based on the perspective imaging line of each stereoscopic unit, the candidate point being an intersection point of at least two perspective imaging lines;
determining the vanishing point from the at least one candidate point based on a distance between the candidate point and each perspective imaging line; and
determining the position of the vanishing point in the image as the vanishing point position.

16. The computer device according to claim 9, wherein the processing the image, to obtain frame information of at least one stereoscopic unit comprises:
cropping the image, to obtain a cropped image comprising the at least one stereoscopic unit;
performing perspective transformation on the cropped image, to obtain a corrected image, a shape of the first surface of the stereoscopic unit in the corrected image being the same as a shape of the first surface in the three-dimensional structure of the stereoscopic unit; and
processing the corrected image, to obtain the frame information of the at least one stereoscopic unit.

17. A non-transitory computer-readable storage medium, the storage medium having a computer program stored therein, and the computer program, when being loaded and executed by a processor of a computer device, causing the computer device to implement a method for determining three-dimensional information of an object including:
obtaining an image of an outer surface of a photographed object, the outer surface of the photographed object having n protruding stereoscopic units, and n being a positive integer;
processing the image, to obtain frame information of at least one stereoscopic unit, the frame information including a first surface and a second surface of the stereoscopic unit in the image, the first surface being parallel to the second surface; and
determining three-dimensional information of the stereoscopic unit based on the frame information of the stereoscopic unit, the three-dimensional information representing a position of the stereoscopic unit in the image and a protrusion degree of the stereoscopic unit in a direction perpendicular to the outer surface.

18. The non-transitory computer-readable storage medium according to claim 17, wherein the frame information comprises a surface ratio representing a size ratio between the first surface and the second surface in the image; and
the determining three-dimensional information of the stereoscopic unit based on the frame information of the stereoscopic unit comprises:
determining position information of the stereoscopic unit based on the surface ratio of the stereoscopic unit, the position information representing the position of the stereoscopic unit in the image;
determining protrusion information of the stereoscopic unit based on the surface ratio of the stereoscopic unit, the protrusion information representing the protrusion degree of the stereoscopic unit in the direction perpendicular to the outer surface; and
obtaining the three-dimensional information of the stereoscopic unit based on the position information of the stereoscopic unit and the protrusion information of the stereoscopic unit.

19. The non-transitory computer-readable storage medium according to claim 18, wherein the image comprises a first stereoscopic unit and a second stereoscopic unit, and a protrusion degree of the second stereoscopic unit in the direction perpendicular to the outer surface is a known reference value; and
the determining protrusion information of the stereoscopic unit based on the surface ratio of the stereoscopic unit comprises:
determining relative protrusion of the first stereoscopic unit based on a surface ratio of the first stereoscopic unit and a surface ratio of the second stereoscopic unit, the relative protrusion of the first stereoscopic unit being configured for representing a protrusion degree of the first stereoscopic unit relative to the second stereoscopic unit in the direction perpendicular to the outer surface; and
determining protrusion information of the first stereoscopic unit based on the relative protrusion of the first stereoscopic unit.

20. The non-transitory computer-readable storage medium according to claim 17, wherein the processing the image, to obtain frame information of at least one stereoscopic unit comprises:
cropping the image, to obtain a cropped image comprising the at least one stereoscopic unit;
performing perspective transformation on the cropped image, to obtain a corrected image, a shape of the first surface of the stereoscopic unit in the corrected image being the same as a shape of the first surface in the three-dimensional structure of the stereoscopic unit; and
processing the corrected image, to obtain the frame information of the at least one stereoscopic unit.
